(19) United States
(12) Patent Application Publication
(10) Pub. No.: US 2026/0088612 A1
(43) Pub. Date: Mar. 26, 2026

(54) CONFIGURABLE PLUGGABLE POWER SOURCE CONTROL SYSTEM

(71) Applicant: Teardrop Power LLC, East Grand Rapids, MI (US)

(72) Inventor: David B. Hartung, East Grand Rapids, MI (US)

(21) Appl. No.: 19/337,053

(22) Filed: Sep. 23, 2025

Related U.S. Application Data
(60) Provisional application No. 63/698,846, filed on Sep. 25, 2024.

(51) Int. Cl. H02J 1/08; H02G 3/08; H02J 1/10; H02J 7/00; H02J 7/35; H02S 10/20; H02S 10/40

(52) U.S. Cl. CPC H02J 1/08; H02G 3/08; H02J 1/10; H02J 7/35; H02J 7/855; H02J 7/933; H02S 10/20; H02S 10/40; H02J 2101/25

(57) ABSTRACT

A power control system includes a pluggable power source (PPS) junction box operable to receive and aggregate power from one or more energy sources. The system includes a PPS controller operable to control an enable signal and provide the power to an energy storage device or direct load device. The system includes a PPS interface operable to communicate the power from the PPS junction box to the PPS controller and communicate the enable signal from the PPS controller to the PPS junction box. The PPS controller controls the enable signal responsive to at least (i) an amount of power available from the one or more energy sources and (ii) an amount of energy stored at the energy storage device or required to supply the direct load device. The PPS interface communicates the power from the PPS junction box to the PPS controller based on the enable signal.

### CROSS REFERENCE TO RELATED APPLICATION

The present application claims the filing benefits of U.S. provisional application Ser. No. 63/698,846, filed Sep. 25, 2024, which is hereby incorporated herein by reference in its entirety.

### FIELD OF THE INVENTION

The present invention relates generally to a power control system and, more particularly, to power control system for solar panels.

### BACKGROUND OF THE INVENTION

Current portable solar equipment is primarily restricted to low-power applications with short interconnect distances to comply with guidelines for managing hazardous power levels. There is a growing need for a standardized system for portable solar panel power systems to address the increasing demand for remote charging and portable battery-powered equipment. A standardized system would allow manufacturers to ensure that their equipment can reliably utilize solar panel-generated DC power for recharging, similar to how standard appliances are connected to the electric grid through cords and outlets.

### SUMMARY OF THE INVENTION

A power control system for solar panels includes a pluggable solar panel (PSP) junction box operable to receive and aggregate power from one or more solar panels. The system includes a PSP controller operable to control an enable signal and provide the power to an energy storage device. The system also includes a PSP interface operable to communicate the power from the PSP junction box to the PSP controller and communicate the enable signal from the PSP controller to the PSP junction box. The PSP controller controls the enable signal responsive to at least (i) an amount of power available from the one or more solar panels and (ii) an amount of energy stored at the energy storage device. The PSP interface communicates the power from the PSP junction box to the PSP controller based on the enable signal.

These and other objects, advantages, purposes and features of the present invention will become apparent upon review of the following specification in conjunction with the drawings.

### BRIEF DESCRIPTION OF THE DRAWINGS

FIG. 1 is a schematic view of a pluggable solar panel (PSP) control system.

FIG. 2 is a schematic view of a complete Type 1 PSP system.

FIG. 3 is a schematic view of a Type 1 two-series solar panel system.

FIGS. 4A and 4B are tables of Type 1 and Type 2 configurable systems.

FIG. 5 is a schematic view of a Type 2 PSP system including a PV+ sampling circuit.

FIG. 6 is a schematic view of a circuit for bidirectional communication over a power and signal interface.

FIG. 7 is a state diagram for a two-wire PSP system.

FIG. 8 is a plot of power and voltage classes versus transfer distance and cost.

FIG. 9 is a grounding diagram for a four-wire PSP system.

FIG. 10 is a grounding diagram for a two-wire PSP system.

FIG. 11A is a schematic view of a cable mate detection feature using a magnetic sensor.

FIG. 11B is a perspective and side view of a connector embodiment for magnetic detection of cable mating.

FIG. 11C is a cross-sectional view of the connector embodiment of FIG. 11B.

FIG. 12 is a state diagram for a solar controller.

FIG. 13 is a state diagram for a battery controller.

FIG. 14 is a generalized block diagram of a communicated and intrinsically safe power distribution system.

FIG. 15 is a circuit diagram of a configurable four-panel photovoltaic power supply.

FIG. 16 is a circuit diagram of a supply-side interface for bidirectional communication.

FIG. 17 is a circuit diagram of a controller-side interface for bidirectional communication.

FIG. 18 is a timing diagram illustrating bidirectional communication over the interface.

FIG. 19 is a circuit diagram illustrating a grounding and cable fault detection architecture.

FIG. 20 is a block diagram of a segmented physical wiring system.

FIG. 21 is a circuit diagram for an intermediate wiring box with a disconnect feature.

FIG. 22 is a block diagram of an exemplary solar panel system implementation with an intermediate disconnect.

FIG. 23 is a functional block diagram of a smart controller capable of multiplexed power distribution.

### DESCRIPTION OF THE PREFERRED EMBODIMENTS

The present state of the art for solar panel installation in uncontrolled environments is to incorporate micro-inverters or module level power electronics (MLPE) which comply with NFPA Rapid Shutdown. Micro-inverters, installed near the solar panel, meet the NFPA safety requirements by converting the panel(s) DC output to a low voltage AC or grid compliant, synchronous AC output which is active only when grid AC power is present. MLPE devices, installed near each solar panel, use a keep-alive signal in the form of RF coupled PLC (power line communication). In both cases, photovoltaic generated power is output only when grid AC power is present, or PLC signaling is not switched off. For each of these methods, if a hazardous condition is present, maintenance or fire response personnel simply turn off Grid Interconnect thereby shutting down the solar power output. Micro-inverter and MLPE approaches turn off AC output or collapse the solar panels individual DC output using active semiconductor(s), respectively, thereby reducing fixed installation power systems to a safe power level. Neither of these approaches would work safely or with guaranteed equipment reliability in an ad-hoc pluggable system. The implementations herein provide intrinsically safe, pluggable renewable energy powering of general equipment loads.

Implementations herein include a power system (e.g., a pluggable solar panel power system) for portable and reconfigurable applications, such as a pluggable power source (PPS), and in some specific implementations, pluggable solar panel (PSP) applications. While a primary example described herein is a Pluggable Solar Panel (PSP) system, the principles and apparatus are applicable to a broader range of Pluggable Power Source (PPS) systems. Accordingly, the term PPS is used hereinafter to refer to the generalized system, with the understanding that PSP may refer to a specific solar panel-based implementation thereof which may be replaced by a suitable PPS system. These applications may help to fulfill the increasing demand for remote charging solutions and portable battery-powered equipment. The system allows manufacturers to depend on solar panel-generated direct current (DC) power for recharging equipment, akin to how standard appliances are connected to the electric grid through a cord and outlet. Current portable solar equipment is generally restricted to low-power applications and short interconnection distances to comply with Occupational Safety and Health Administration (OSHA) guidelines for safe power levels. The use of the systems and methods herein mitigate these constraints by facilitating longer distances between solar equipment and charge controllers, while also enhancing the reliability of solar equipment with minimal impact on cost. This may lead to a significant boost in the integration of solar power into various applications.

The system includes a PPS or PSP interface characterized by a four-wire interconnection system. This interface delivers solar power through two dedicated wires or contacts, while the remaining two wires or contacts are reserved for control or enabling power. The system ensures that solar power is only available on the power wires when a low voltage enabling signal is received from the control device or appliance. The solar panel's output power is transmitted directly through the power wire pair, with the output voltage capped at a maximum voltage (e.g., 300 volts direct current (VDC)) and the current limited to a maximum amperage (e.g., 20 amperes). The PPS interface, via a startup sequence, provides interconnect verification, promoting the cost-effective and safe operation of solar panel energy for PPS-compatible loads, where the powered equipment integrates the more sophisticated and expensive components, such as the charge controller and battery energy storage.

The system is designed in accordance with the RV Industry Solar Power Standard for low voltage DC systems, such as those operating at 60 VDC and under, and adheres to OSHA regulations that classify voltages higher than 30 VDC as harmful. The system ensures that solar power and system controller interfaces do not present harmful voltages on the connector or interface wire when any single interface is disconnected.

Additionally, the system provides a cost-effective and straightforward means for manually disconnecting power from the solar power interconnect. The system supports various power levels, maximum distances for power transfer, and failure mitigation, all while minimizing costs.

The PPS system categorizes interface and power levels into multiple types. Type 1 configurations involve solar panels operating at 100 VDC and lower, utilizing a four-wire interface where power can be enabled by simply applying battery voltage to the enable signal. Type 2 configurations support up to 300 VDC solar panels, with solar output power being configurable. The operation of the power interface in Type 2 requires a smart solar power junction box and a smart Maximum Power Point Tracking (MPPT) or battery side controller. Both Type 1 and Type 2 interfaces use the same four-wire interconnect. Type 3 configurations also support up to 300 VDC solar panels but manage power on and off states through smart control over a two-wire interface.

Individual solar panels typically generate between 15 to 50 VDC, with a current range of 5 to 15 amperes at the maximum power point tracking (MPPT). These panels vary in size, with a power output ranging from 50 to 600 watts. To minimize power loss across extended wiring interfaces, the solar panels are generally configured in a series circuit, which increases the voltage while maintaining the panel's rated current. When panel voltages exceed 30 VDC, OSHA mandates specific safe handling procedures, and the National Electrical Code (NEC) requires a disconnect mechanism for solar panels to ensure personnel safety. The power system herein addresses these requirements by providing configurations for series and series-parallel circuits that aggregate raw solar panel power. This aggregation facilitates enhanced power transfer across the extended wiring system while adhering to OSHA and NEC safety standards. The system provides discrete ranges of output for both voltage and current, which are determined based on the typical designs of various energy storage systems and their associated charge controllers (MPPT). Consequently, the power input to the charge controller and battery system is tailored to meet the needs of most systems, which generally require a voltage overhead above the battery voltage to enable efficient charging. The following table illustrates exemplary combinations of voltage and power transfers supported by the system.

Voltage Range Table

| Typical | PPS Output | | Power | |
|---|---|---|---|---|
| Battery | Range | EN Voltage | Transfer | Controller/ |
| Voltage | (Class) | Range | (Max) | Class |
| 12/14 VDC | 17 to 50 VDC | 9 to 15 VDC | 1 KW | 50 VDC Max, |
| | | | | Class 1 |
| 24/27 VDC | 34 to 100 VDC | 19 to 30 VDC | 2 KW | 100 VDC Max, |
| | | | | Class 2 |
| 48/56 VDC | 69 to 150 VDC | 40 to 58 VDC | 3 KW | 150 VDC Max, |
| | | | | Class 3 |
| 72/78 VDC | 96 to 300 VDC | 64 to 96 VDC | 6 KW | 300 VDC Max, |
| | | | | Class 4 |

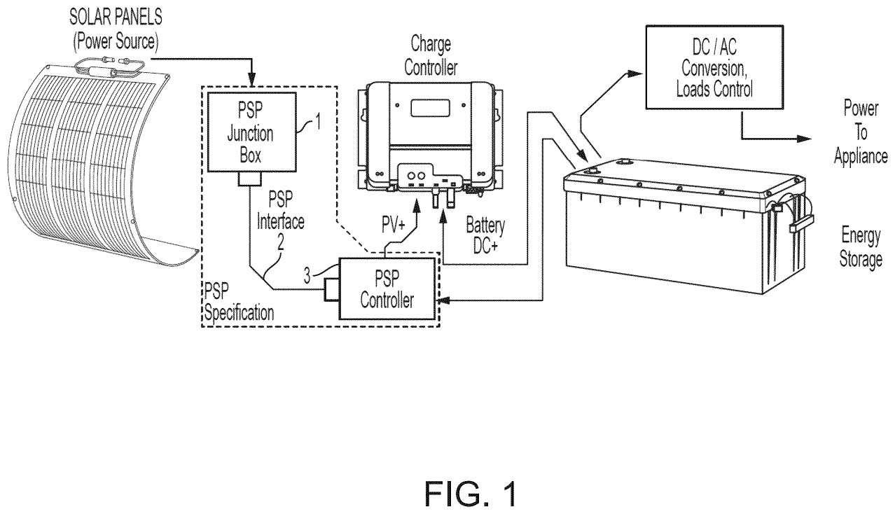

FIG. 1 illustrates a generalized solar panel power system that implements the PSP interface (or more generally a PPS interface). This power system encompasses several components, including a PSP junction box 1 (or PPS junction box), the PSP interface 2, and a PSP controller 3 (or PPS controller). The PSP Junction Box 1 serves as the primary connection hub for the solar panels. This junction box 1 is positioned in close proximity to the panels to facilitate efficient energy transfer. The PSP Interface 2 is a 4-wire system that is responsible for the essential control and power wiring. This interface extends between the junction box 1 and the charge controller system, ensuring a seamless flow of electricity and information. The PSP controller 3 may co-located with the charge controller and the energy storage system. The PSP controller 3 regulates the power distribution and storage within the solar panel system. The PSP system may outline the operational parameters for each of these components 1-3 to guarantee not only their interoperability but also the safe and compatible transfer of power throughout the system.

The PSP system may define distinct types and classes to categorize and distinguish capabilities of the system. The types are indicative of the configuration options that the interface can support. Specifically, Type 1 is characterized as a single configuration, which is designed to support a singular photovoltaic voltage level. Type 2, known as dual configuration, is capable of supporting two distinct photovoltaic voltage levels, offering both half and full voltage outputs, denoted as 1× and 2×, respectively. It is important to note that the system may include or support additional types that would accommodate more intricate or complex solar panel configurations.

Classes, on the other hand, are defined by discrete ranges of output voltage levels along with their corresponding maximum power transfer capabilities. These classes are outlined in the table above. The system's design, as illustrated in FIG. 1, presents a typical arrangement consisting of a solar panel, a charge controller, and battery components, with an inverter facilitating the conversion to AC power output. The PSP junction box 1 and PSP interface 2 are integrated between the solar panels and the charge controller. This integration serves to enhance the functionality of the overall solar power system. The PSP junction box 1, in particular, serves as a hub for multiple solar panels, which are connected through, for example, MC4 solar panel connectors. This configuration accommodates a series or a combination of series and parallel configurations of solar panel power output directed towards the charge controller, while also adhering to the physical constraints of the system. The PSP junction box 1 is positioned in proximity to the solar panels and may be designed to meet IP67 environmental requirements for outdoor placement. By centralizing the panel power at or near the PSP junction box 1, the output power may be transmitted via a single physical interconnect over a significantly extended distance to the charge controller and battery components, which are typically situated at a further distance.

The PSP interface 2 transmits solar panel power over long distances, utilizing either portable wiring with plugs and cords or permanent protected wiring that leads to the charge controller. The aggregation of panel interfaces not only reduces wiring costs but also ensures that the system provides a safe and efficient method for the wiring or cable to transport the power to the charge controller and battery components.

The system may include a switch that is responsible for activating power on the interface. In simpler systems, this switch may be a Single Pole Single Throw (SPST) device that provides a current-limited DC bias from the battery when in the ‘on’ state. By default, solar power is generally set to the ‘off’ state, which corresponds to the switch being open or the wire being disconnected. In many systems, the switch function is controlled by the charge controller, which activates the optimal power configuration necessary to fulfill the battery charging requirements during periods when sunlight is available.

As used herein, the term “intrinsically safe” defines a photovoltaic (PV) power output that is designed with multiple layers of control elements. These elements work in tandem to ensure that, in the event of any single point failure, the system will default to an open contact operation, effectively preventing any power output and maintaining safety. The terms “fault detecting” and “auto-safe” refers to the capability of the PSP junction box 1 to detect any ground fault current that equals or exceeds a threshold current (e.g., 30 milliamperes) between the positive and negative PV terminals. Upon detection of such a fault, the system may be programmed to transition to an open-output state, or a powered-off condition, within a short time frame (e.g., less than 15 milliseconds), thereby safeguarding against potential hazards.

The system also incorporates “isolation” or “ground” measures, which are designed to maintain ground isolation in excess of a threshold resistance (e.g., 1 megohm). This ensures that even with a significant (e.g., 1000 VDC) offset between grounds, the system will not experience failure, thus providing an additional layer of protection.

The output voltage levels of a solar junction interface may be categorized into types, denoted as “Type (1−x).” For instance, a Type 1 interface provides a single output voltage level, while a Type 2 interface offers dual output voltage levels. The system may also include a Type 3 interface, which provides configurable output with high voltage/high power capabilities up to Class 4, over the two-wire defined interconnect. Additional Type(s) may be added to accommodate industry needs, while operating on 4-wire and 2-wire configurable PSP interfaces as discussed herein. The “Class (1-n)” designation refers to the supported voltage output levels, with Class 4 supporting the highest voltage range of 150 to 300 VDC. These classes are defined within the table above.

A “charge controller” is a component that receives PV power. Typically, this includes a Maximum Power Point Tracking (MPPT) mechanism that converts the wide-ranging DC energy from the PV into regulated power suitable for battery storage. The charge controller also encompasses protection devices, disconnect components, and a user interface. In the context of a PSP system, the charge controller is also responsible for controlling the PSP enable function. A “junction box” is associated with the solar panel side of the PSP interface, where it plays a role in energy output. In contrast, the “wire harness” is the cable interface that connects the junction box to the charge controller, facilitating the transfer of energy.

The term “system controller” (also referred to herein as the PSP controller) is used to describe the specific processor located within the charge controller that is tasked with several functions. For example, the system controller controls the PSP enable function, communicates with the junction box, checks the integrity of the cables, and hosts the user interface. This interface allows for the management of the overall state of charge and the supply of energy to the loads.

Additionally, “advertisement” refers to a resistor-divided PV+ output voltage relative to PV−, which is presented by the junction box before the supply of solar power commences. This advertisement voltage is a current-limited, resistor-divided sample of the solar panel's default configuration voltage. Its purpose is to signal to the system controller the availability of daytime solar energy and to provide an approximation of the panel system's operating voltage.

The following describes the PSP interface 2 (FIG. 1) in more detail. The PSP interface 2 may be an integrated 4-wire system that serves both power and signal functions. This interface is composed of a pair of power wires and a pair of signal wires, each with distinct characteristics and roles. The first wire in the power pair is designated as the positive power wire, referred to as “PV+.” This wire is responsible for delivering solar power from the PSP output. It is capable of handling a large maximum voltage (e.g., greater than 200 VDC, such as 300 VDC) and a maximum current of, for example, 20 amperes. The PV+ wire is defined with respect to the second wire in the power pair, the negative power wire (PV−). The PV− wire serves as the solar power return for the PSP output. It is characterized by its floating status with respect to the earth ground and the Enable Return (discussed below), which means it is not directly connected to the ground but instead references the positive power wire, PV+.

For the signal wires, the first is the Enable signal wire, labeled EN+. This wire functions as an input signal for the PSP and can carry a voltage ranging from, for example, 0 to 96 VDC maximum. Exemplary peak loading specifications for the EN+ wire, when interfacing with the PSP junction interface box, are detailed in the table above. The EN+ wire is referenced against the Enable reference wire, EN_RTN. The Enable reference wire, EN_RTN, is the second of the signal wires. This wire acts as a referenced ground for the charge controller and/or battery system. The EN+ and EN_RTN wires together facilitate not only the control power but also the communication of status flags and the integrity of the overall junction box and its associated wiring and interface.

In summary, the electrical interface is designed to ensure efficient power delivery and effective communication between components. The PV+ and PV− wires provide a robust power supply, while the EN+ and EN_RTN wires enable control and monitoring of the system's performance. This configuration helps define the interface's capability to manage both power and signal in a harmonized manner.

The PSP junction box may include an electrical interface on a TE Connectivity connector (e.g., model RTS712N2P03 or an equivalent). The signal/contact allocation for this connector includes PV+ on a, for example, 23 ampere, 500 VDC rated contact with a 2.5 mm male pin at position A, and PV− on a similar contact at position B. The enable signal (EN+) is allocated to a 5 ampere, 500 VDC rated contact with a 20 #male pin at position 1, while the enable reference (EN_RTN) is on a similar contact at position 2. In this example, the connector is rated IP67 and IP69K when mated, ensuring robust environmental protection.

The PSP junction box may be equipped with a jam-nut receptacle (e.g., from the RTS712N2P03 Sine Systems family). This receptacle is a 4-position (2+2) pin contact size 12 IAW. The contact references include male pins suitable for 12-14 AWG tin crimp (requiring two for power) and male pins suitable for 20-22 AWG SZ20 crimp (requiring two for signal).

Using the jam-nut receptacle at both the panel junction box and the charge controller is beneficial in order to complete the PSP interface efficiently. The wire harness is defined with plugs having female contacts at both ends, making it symmetrical and interchangeable. This design allows for a portable system with a separate cord style of interconnect, ensuring that each end of the plug can be used interchangeably. Since no power or harmful voltage is present at a non-connected PSP receptacle, there are no safety concerns regarding exposed pins or female contacts on a partially connected cable. Power and potentially harmful high voltages are only present when the connectors or interface are fully connected with verified interconnect integrity by design.

The PSP, as discussed above, defines a four-wire interface that provides output power (PV+, PV−) when enabled via the input signal pair (EN+, EN_RTN). In all cases, PV power, defined as having a current output of greater than a threshold (e.g., 1 ampere) with a voltage output of at least a threshold (e.g., 15 VDC and higher) on PV+ with respect to PV−, remains inactive until the Enable signal is provided. The Enable function is determined by the voltage and current on the EN+ with respect to EN_RTN, which is supplied from the system controller to the solar panel (Junction Box) at specific voltages. For Class 3 and Class 4 operations, the interface may only function when EN+ is at a voltage greater than, for example, 30 VDC after verifying interconnect integrity through affirmative completion of startup integrity checking.

For Class 1 and Class 2 operations, EN+ with respect to EN_RTN may be powered at any time by the controller, provided the voltage does not exceed a threshold voltage (e.g., 30 VDC) with respect to EN_RTN. Additionally, for these classes, PV+ with respect to PV− may be powered by the controller at any time while the controller output voltage does not exceed the threshold voltage when Enable+ (EN+) is floating with respect to EN_RTN. In the default single output case, PV+ with respect to PV− (and all other surfaces and signals) shall not exceed the threshold voltage at any time prior to complete wiring interconnect and a minimum time delay (e.g., 1 second). The PSP output power (PV+ with respect to PV−) for all classes shall be intrinsically safe (off state) with less than the threshold voltage at the PV+ with respect to PV− when disconnected and when connected but not enabled.

Before receiving EN+ enabling power, the PV+ with respect to PV− output provides a resistor-divided solar panel default output voltage signal of, for example, 30 VDC maximum, equivalent to a solar panel voltage of 300 VDC (i.e., a 10:1 resistor-divided output). This output is capable of sustaining a long-term short circuit without damage and may be limited to a maximum of 25 milli-amperes.

These specifications ensure compliance with ANSI/RVIA standards for low voltage systems in conversion and recreational vehicles, which define a low voltage system as having a maximum of 60 VDC. According to OSHA, a DC voltage greater than 50 VDC with a current of 25 milli-amperes or higher is considered hazardous. Additionally, a low voltage battery system of 24 VDC configured from Lithium Iron Phosphate cells is approximately 29 VDC at maximum charge. Setting the output EN+ limit at 30 VDC meets both ANSI/RVIA and OSHA thresholds for a simple Class 1 and Class 2 design, thereby limiting potentials at the cable interface prior to complete connection. Note that PV+ voltages above 50 VDC are not present until after the complete wire harness, junction box, and controller interconnect is made.

This design allows for a simple system design that implements a time-delayed (on) SPST relay in 12/24 VDC battery systems to enable power to the charge controller without the additional burden of performing fault detection or other cable integrity tests. The system may provide a current-limited manual switch at the controller and delayed (after EN+ is received at the junction box) PV+ output from the junction box. The time delay (e.g., 1 second) ensures connector mating is complete. In the event that a cable is disconnected while the EN+ output remains, cable (contact) voltages are kept under 30 VDC.

When disconnected, the PSP Interface 2 is designed to have a current-limited maximum voltage of, for example, 50 VDC on any contact, with the current limited to, for example, 10 mA, ensuring that a 10 mA load results in 10 VDC or less on the interface. When not enabled by the application of a voltage on the EN+, the PV+ relative to PV− will advertise the default solar panel voltage case and present solar conditions using an open circuit voltage via a 10:1 divider ratio. This configuration provides a maximum output of 30 VDC on the PV+ to indicate that power is available to a charge controller, with PV+ being limited to 5 milliamperes in the advertising state. The system supports advertising the solar panel power state to facilitate a smart enable function, where the controller applies the enable input only when sunlight is detected. However, charge controller support for advertisement is not mandatory.

For PSP outputs capable of exceeding 50 VDC, intrinsic safety measures may be required. Outputs capable of providing 150 VDC or more may incorporate a fault-detecting, auto-safe output control design. When connected within a PSP fault-detecting, auto-safe controller system, the PSP Interface can have a maximum voltage of 300 VDC on the power contacts. The maximum voltage on the power enable contacts is 50 VDC for Class 1 and 2 PSP systems (up to 100 VDC PV output), thereby meeting the initial power interface requirement. For Class 3 and 4 PSP systems (up to 300 VDC output), the enable voltage is capped at 100 VDC and is not applied by the charge controller until PSP advertisement indicates the presence of solar power equivalent to 69 VDC or greater. Consequently, Class 3 and 4 PSP systems also comply with the 50 VDC maximum requirement when disconnected.

Regarding the control/enable interface, the power output may be in the off state (PV+<2 VDC relative to PV−) when the EN+ is connected to EN_RTN. The power output can reach up to 50 VDC when the EN+ is biased above 9 VDC relative to EN_RTN. The power output may exceed 50 VDC only when the EN+ is at least 19 VDC relative to EN_RTN.

The system supports various configurations of multiple solar panels, including series, parallel, and series/parallel arrangements. The PSP Junction Box is designed to accommodate these configurations with different types and classes of junction boxes.

Type 1, known as the Single Output Junction Box, is designed to support a single output, such as a single MPPT charge controller. Junction boxes of this type that support outputs of less than 50 VDC are not required to advertise the current solar power state. Type 2 Junction Boxes, on the other hand, support two or more output configurations, allowing for multiple series/parallel options of the solar panel inputs. These junction boxes must advertise the panel voltage in the default configuration relay state.

For single output voltage configurations, there are several class options. Class 1 Junction Boxes support a single photovoltaic (PV) voltage up to 48 VDC with a minimum MPPT output voltage of 17 VDC, ensuring the charging of 12V DC batteries. Class 2 Junction Boxes support a single PV voltage up to 97 VDC with a minimum MPPT output voltage of 34 VDC, guaranteeing the charging of 24V DC batteries. Class 3 Junction Boxes support a single PV voltage up to 144 VDC with a minimum MPPT output voltage of 69 VDC, ensuring the charging of 48V DC batteries. Finally, Class 4 Junction Boxes support a single PV voltage up to 240 VDC with a minimum MPPT output voltage of 96 VDC, guaranteeing the charging of 72V DC batteries.

The operation of the PSP Junction Box is designed to ensure safe and efficient power management. The PV output must be present on the interface no sooner than, for example, 200 milliseconds and no later than, for example, one second after the application of the EN input. This timing allows for the switching of relay-controlled configurations and power output while ensuring that solid-state relays (SSR) or semiconductor controls remain off. All power switching is designed to occur with the relay in an open state (also known as dry switching), preventing current flow and ensuring arc-safe transitions in compliance with standard DC relay application requirements.

Additionally, all PSP Junction interfaces must support the continuous application of EN+ at 90V DC or less without resulting in failure, loss of PV+ output, or drawing excessive current that could lead to charge controller failure. This ensures reliable and safe operation under specified conditions.

The charge controller may be designed to provide EN+ as a circuit-protected battery supply output to activate PV power for the system. It includes a manual disconnect switch that removes EN+ for all systems implementing a PV supply of 50V DC and higher. The charge controller may sample the PV+ (with respect to PV−) to determine if sufficient solar power is available and to set the required configuration voltage on EN+. If the received voltage is less than 2.0V DC, it indicates either low incident solar radiation or that the system is not capable of supplying greater than 50 VDC.

When operating with 12V DC storage, the charge controller may provide 12V (Battery +) at a maximum of 2.0 amperes on EN+ with respect to EN-RTN (Battery −) when charging is needed. This can be achieved via a simple switch circuit (non-smart control), a switch and user-controlled logic, or a simple direct (fuse-limited) supply of battery output. The Charge Controller must support a minimum input PV+ of 50V DC. However, sourcing 12 VDC on EN+ does not guarantee a PV+ of greater than 20 VDC and therefore will not charge a 24V DC battery. If the charge controller operating with 12V DC storage provides 24V DC EN+, it must be capable of handling PV+ input up to 100V DC.

For a charge controller operating with a 24V DC bias of EN+ with respect to EN-RTN, it may source a maximum of 1.5 amperes and support PV+ input up to 100V DC. When operating with a 48V DC bias of EN+ with respect to EN-RTN, it may source a maximum of 0.8 amperes and limit the maximum output EN+ voltage to 56V DC. A charge controller providing greater than 50V DC bias of EN+ may be capable of continuously supplying a current-limited output with a maximum of 0.8 amperes and a minimum of 0.5 amperes.

A charge controller providing a 48V DC bias may monitor PV+ with respect to PV− in advertisement mode and verify a minimum input of 4.0V DC before applying the EN+ output. When operating with a 72V DC bias of EN+ with respect to EN-RTN, the charge controller may source a maximum of 0.5 amperes and support PV+ input up to 250V DC. A charge controller providing greater than an 80V DC bias of EN+ may be capable of continuously supplying a current-limited output with a maximum of 0.6 amperes and a minimum of 0.4 amperes.

A charge controller providing a 72V DC bias shall monitor PV+ with respect to PV− in advertisement mode and verify a minimum input of 6.0V DC before applying the EN+ output. Additionally, a charge controller providing 48V DC and higher EN+ output (active) shall monitor PV+ with respect to PV− for continuous reception of at least 30V DC and shall remove the EN+ output within 5 milliseconds if the PV+ falls below the 30V DC threshold. This condition may occur due to intermittent solar radiation or the removal of the PSP wired interface. When it occurs, the PV+ input may return to advertisement mode, thereby supporting restart when solar radiation is sufficient, and the wired interconnect is re-established.

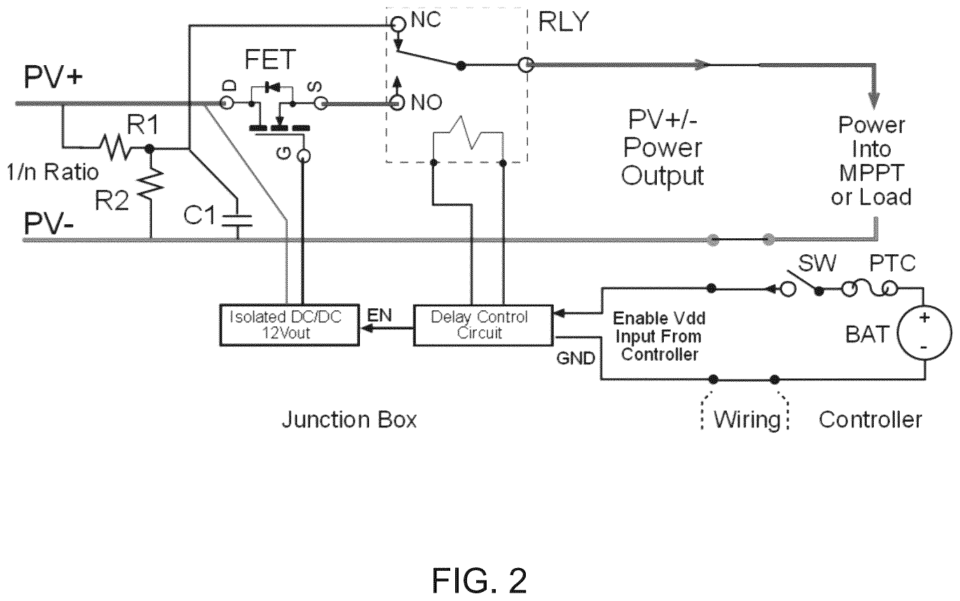

FIG. 2 illustrates a complete Type 1 Pluggable Solar Panel (PSP) system, showing the series FET and Relay circuit of the Junction Box on the left, the PSP Interface wiring in the center, and the Controller components on the far right. The circuit topology is designed to deliver an intrinsically safe PV+ output while addressing issues related to relay contact arcing and in-rush overloading, which can lead to premature relay failure. This intrinsic safety is primarily achieved within the Junction Box by incorporating delay/control logic that ensures the relay is closed before the NFET is activated, thereby maintaining zero current and zero voltage across the relay contacts during turn-on. Conversely, during turn-off, the NFET is deactivated before the relay is de-energized, which effectively eliminates the arc failure mode. The Controller components depicted on the far right represent a minimal embodiment for a Type 1 system, providing a simple and cost-effective Enable circuit. This circuit includes a switch (SW), a current-limiting resettable fuse or Positive Temperature Coefficient (PTC) device, and the DC battery (BAT). In operation, the switch (SW), which may be a simple manual switch, applies a DC bias from the battery (BAT) to the EN+ line of the interface to request power from the Junction Box. The PTC device provides current-limiting protection for this Enable signal. This configuration provides the minimal Enable circuit for a Type 1 PSP interface, wherein a simple, circuit-protected battery supply output is used to activate the PV power.

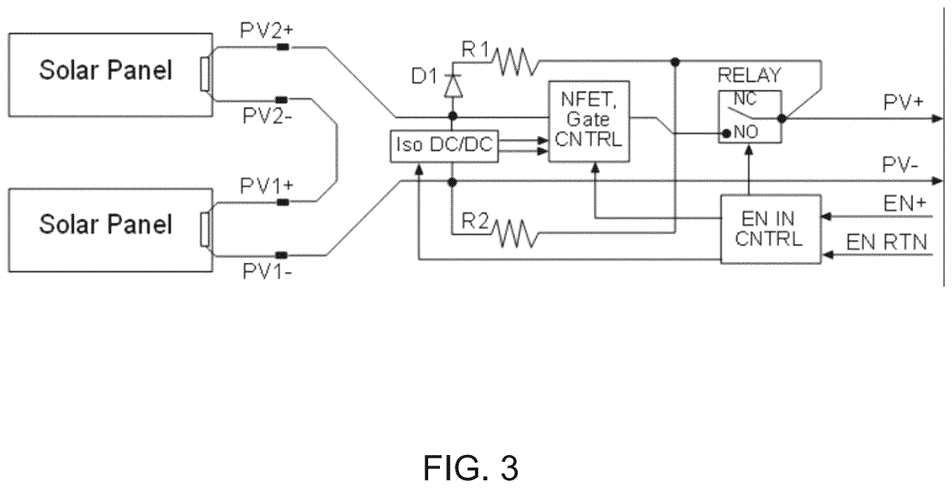

FIG. 3 illustrates an exemplary block diagram of a Type 1 series solar panel configuration. This configuration delivers a 34V DC MPPT supply of solar energy through an NFET and relay circuit. An isolation DC/DC converter is employed to provide the gate voltage, which is regulated by the enable input. The gate supply for the NFET is further managed by an opto-isolator, which is not explicitly depicted in the NFET Gate Control (CNTRL) block. This opto-isolator facilitates rapid on/off control of the NFET via the input EN+ bias and delay logic, as represented in the EN IN CNTRL block. The output power from the PV panel is directed through a Single Pole Double Throw (SPDT) relay. In its default state (normally open, NO), the relay allows the raw PV panel voltage to be sourced through resistors R1 and R2, which have a 10:1 ratio. When the EN+ signal is applied, the relay closes, and after a brief delay, the NFET is activated to supply the PV+ output power. On the controller side, the EN+ signal can be provided by manually switching on the battery voltage.

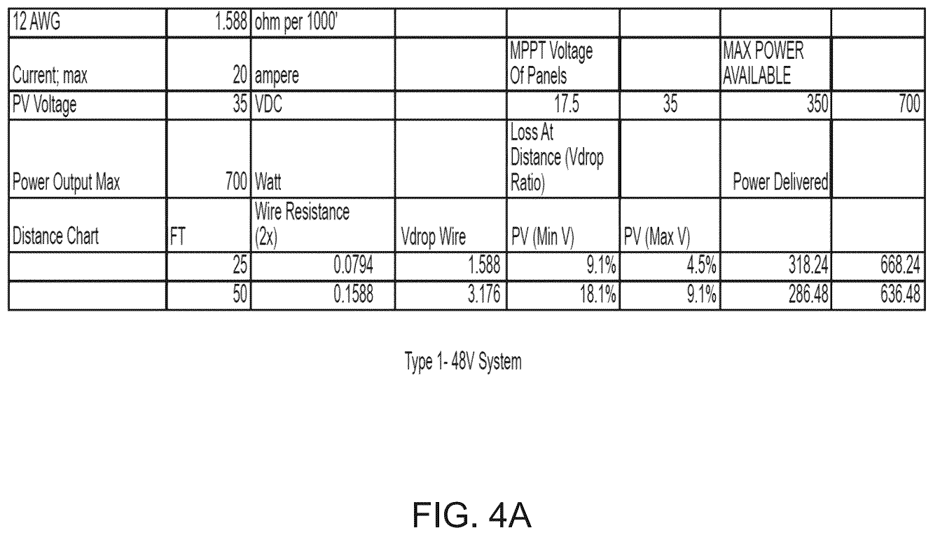

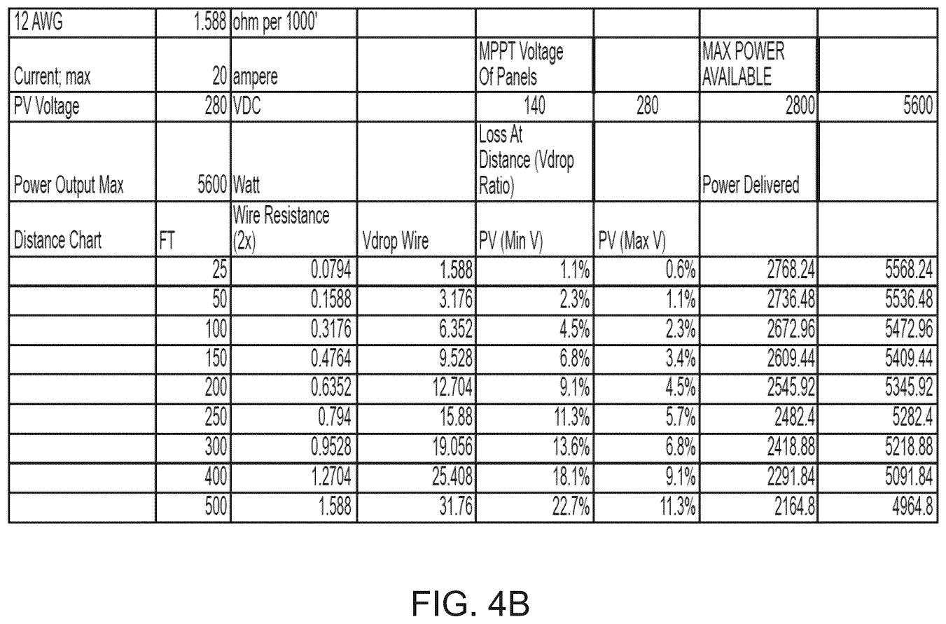

The 24V battery storage system (FIG. 4A) may operate with a minimum recommended input voltage of 34 VDC at the MPPT point to ensure the battery is charged. However, the power transfer level is limited to 700 watts for short distances and to 636 watts for distances up to 50 feet. In contrast, the 48V battery system (FIG. 4B) requires a minimum MPPT point of 65 VDC, necessitating the use of four solar panels connected in series. This configuration allows the power level to increase to 1270 watts, which can be transferred with less than 10% loss over a distance of up to 100 feet.

Type 2 systems, which include 12V/24V and 48V/72V configurations, can operate with higher voltage MPPT controllers rated at either 150V or 300V. These systems are capable of functioning with larger series solar panel configurations. For instance, a solar panel system with a peak output current of 140 VDC can provide 2545 watts over a distance of 200 feet, while a design with a peak output of 280 VDC can deliver 5091 watts over a distance of 400 feet. The percentage of power loss increases as the distance between the solar panel and the controller or battery increases, as shown in the accompanying table. Additionally, the temperature limits of the insulation material for the power conductors and the overall temperature rise in the environment must be considered, as these factors may further limit the carrying distance.

Safe transfer of power necessitates that conductors on the interface are maintained at zero volts through an air-gap mechanism, rather than relying solely on a semiconductor-based switch, when the interface is off or disconnected. However, controlling high voltage DC using only a power relay is not feasible because the contacts are not rated for operation above 30 VDC in conjunction with the currents required for solar power transfer. Typically, relay manufacturers specify that for voltages greater than 30 VDC, the current becomes limited to a few milliamperes. To address this limitation, the system may (across some or all type categories) incorporate a series power FET and relay circuit. This circuit first removes the current in the power conductors by turning off the power FET, and then opens the relay contacts. This timed method ensures that there is no arcing at the relay contacts and that the system complies with the power relay manufacturing specifications.

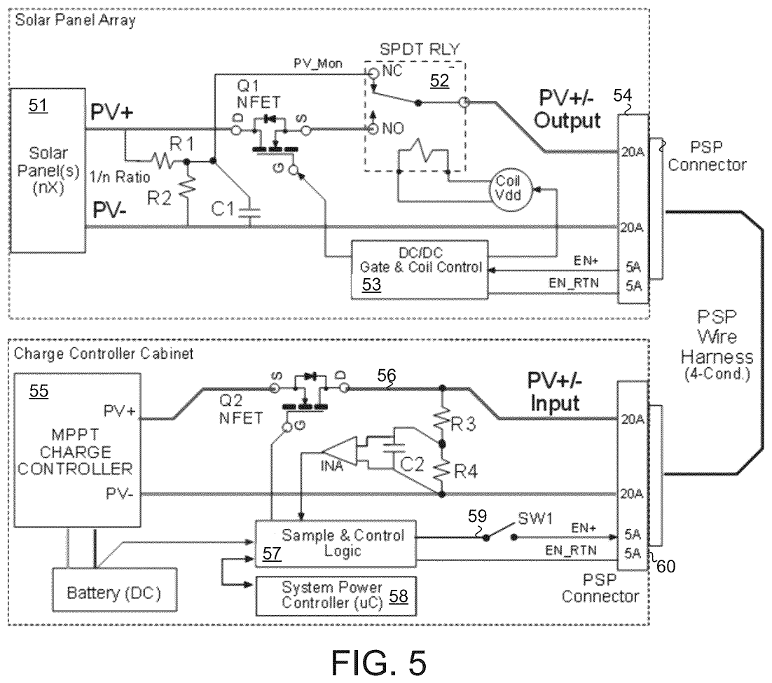

In FIG. 5, the PV side controller and solar panel junction are depicted within a box encapsulating devices 51-54, while the MPPT/charge controller side is represented by devices 55-59. As part of the smart Type II controller implementation on the MPPT/charge controller side, FIG. 5 illustrates a high impedance resistor divider that samples the PV+ line. This divider allows the controller to safely monitor the voltage on the PV+ line for detecting the advertisement signal from the solar panel junction box. By sampling this divided voltage, the controller can determine if sufficient solar power is available before it provides the EN+ signal to activate the high-power output, in accordance with the negotiation and startup sequences described herein. The 4-wire interface is illustrated to the left, with the user-intended disconnect being the receptacle/jack device 60.

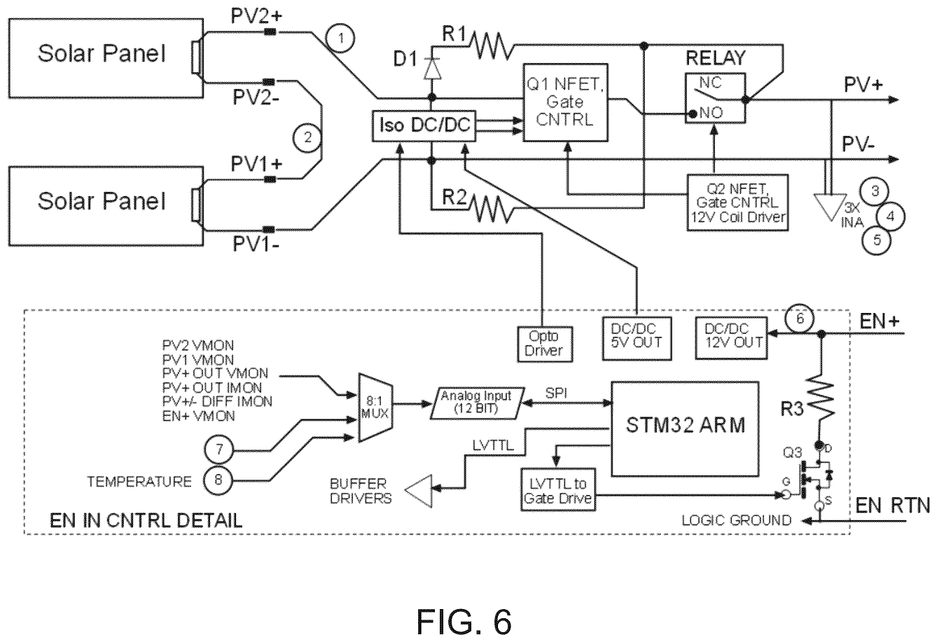

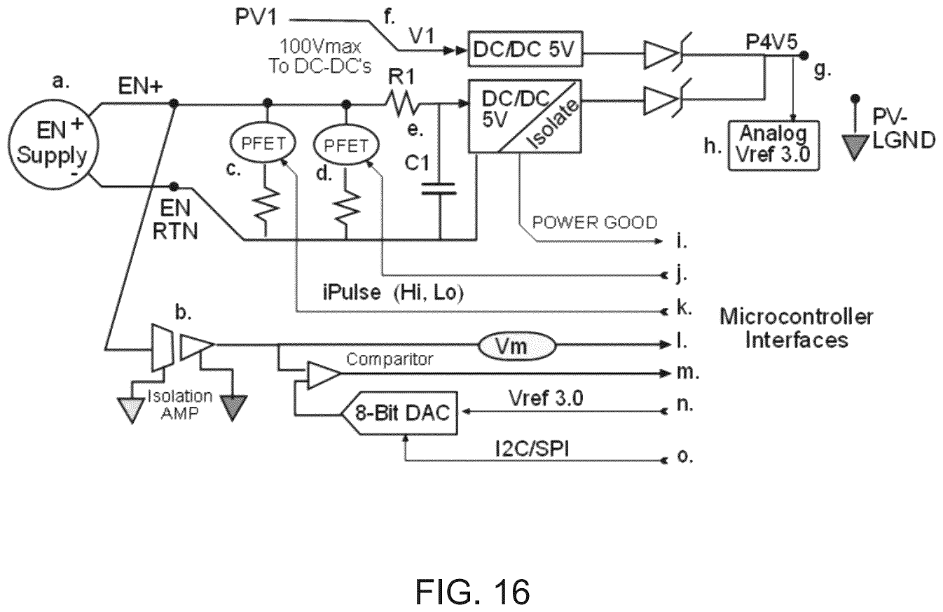

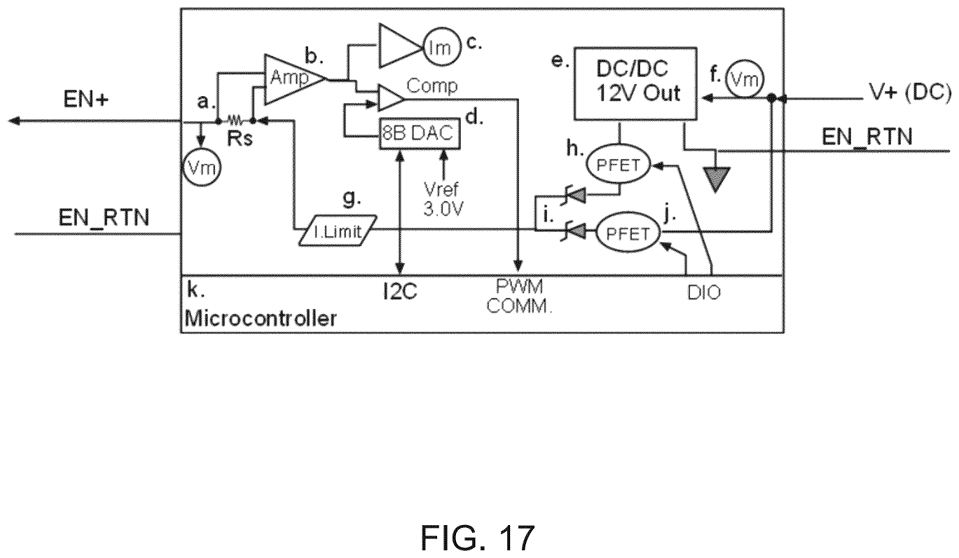

FIG. 6 illustrates the NFET resistor R3, which serves as a standard load on the EN+ line, facilitating Type 2 (and Type 3) current pulse communication to the MPPT controller as part of a bidirectional communication protocol over the EN+ signal, which may be referred to as a Two Wire Current-Voltage-Power (TWIVP) protocol. This protocol provides a low-cost means of communicating compatibility and layered data transfer between the energy supply end (e.g., the solar junction box) and the load end (e.g., the MPPT/charge controller) without requiring a separate, dedicated communication interface. The microcontroller (e.g., a STM32 ARM microcontroller) or other processor utilizes this discrete loading mechanism to transmit startup built-in test and capability data to the MPPT controller. This transmission is achieved by modulating the current drawn on the EN+ line. Conversely, the load end transmits data back to the supply end by modulating the voltage of the EN+ signal, and the supply-side controller receives this data by demodulating the amplitude of the EN+ input voltage. This configuration for bidirectional data transfer ensures reliable communication and data transfer between the microcontroller and the MPPT controller, thereby enhancing the overall efficiency and functionality of the system. Exemplary circuit implementations for the supply-side and controller-side of the TWIVP interface are shown in FIGS. 16 and 17, respectively.

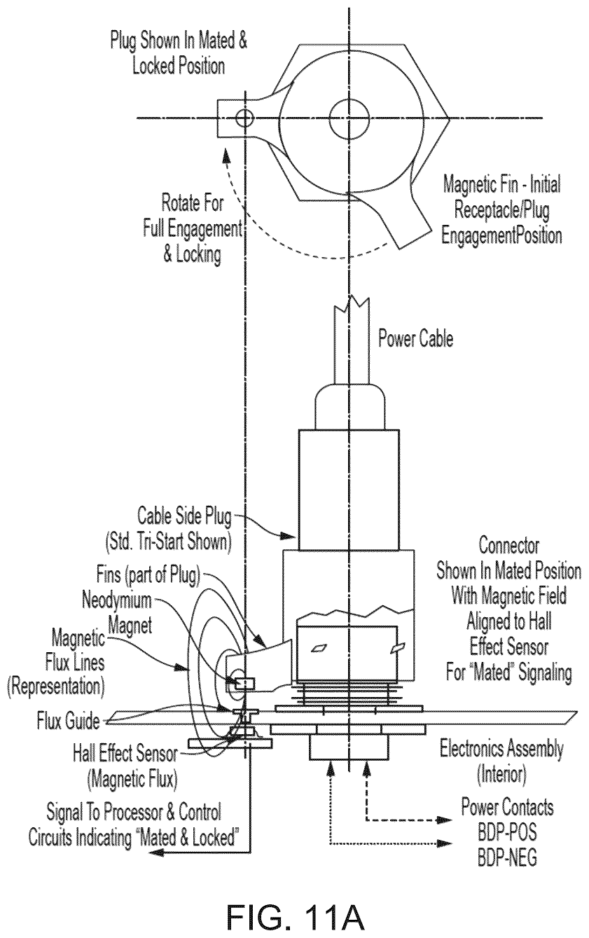

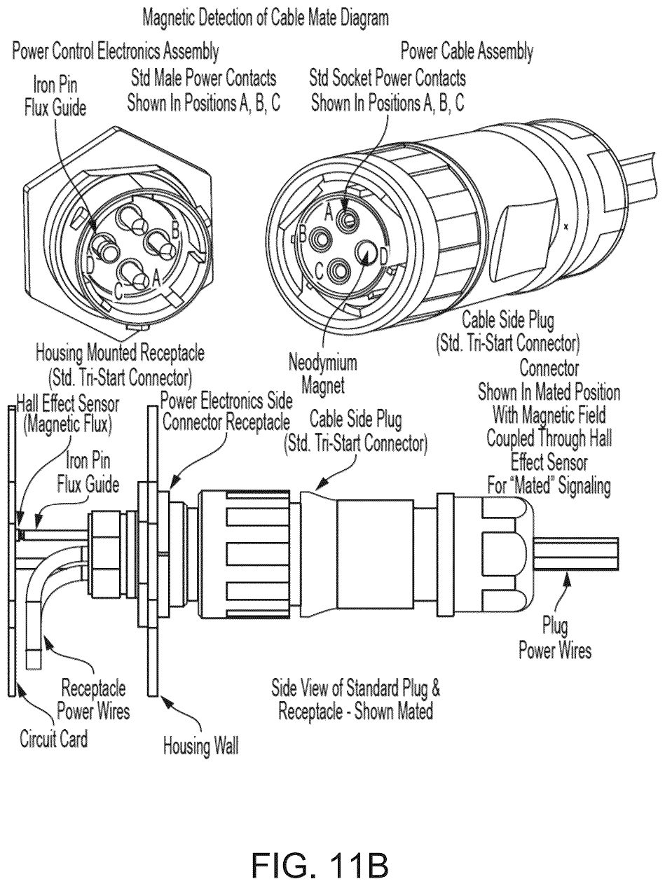

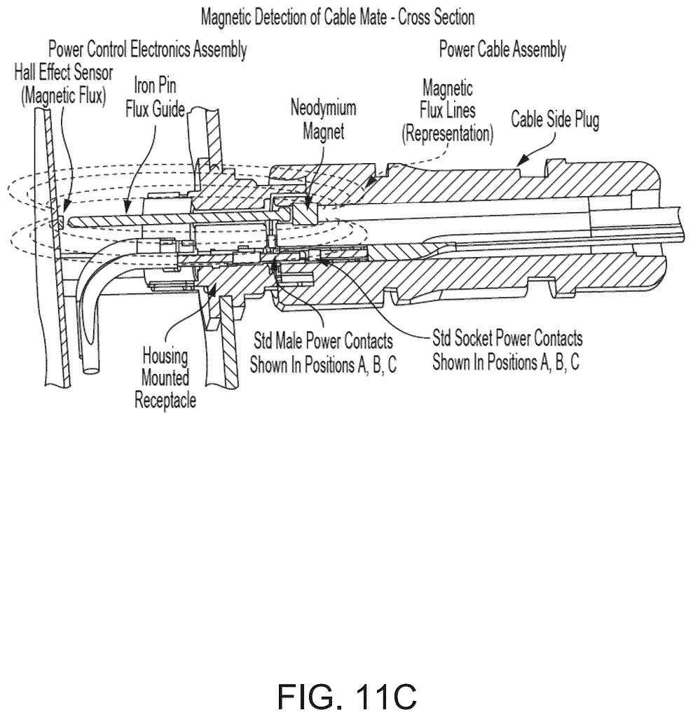

In general, a negotiated power interface is specified whereby the solar junction only activates power at non-safe levels after the interconnected wiring system is verified, and the controller provides the appropriate startup and power level signaling. The controller, operating from battery-stored energy, may issue a startup command (signal) at any time using a safe output voltage (e.g., under 30 VDC). Since the interface is designed to support long distances and high power in an efficient and cost-effective manner, it is possible to utilize a reduced wiring set. The specified Type 1 and Type 2 configurations with a 4-wire interconnect meet these objectives but may not be optimized. To meet the fundamental requirements, the system must provide: verification of cable connected integrity with voltage/signals under 30 VDC; power on sequencing after verification of cable integrity such that relay contact closure occurs before semiconductor-controlled power transmission (Startup), and similarly at disconnect or shutdown, the semiconductors must open first and then the relay contacts; verification of power control integrity (Built-In Test) at both the solar and controller ends; mitigation of faults along the transmission interface, including voltage and current monitoring as well as ground faults and potential parallel circuit faults in solar panels, ensuring fail-safe operation; and cable removal detection with immediate shut-off of solar power to eliminate contact arcing via detection circuits that ensure power is removed from the power conductors before the male/female contact is opened. This could be achieved using different length contacts (short contacts for EN+ or the “connection” wrap signal), a mechanical switch design that signals full mating, or a fast current feedback-based disablement of the power semiconductors. Optionally, the use of magnetic proximity sensing (FIG. 11A) to provide the Enable signal may be implemented in lieu of the short pin contact method or other methods. The magnetic proximity sensing technique supports a hermetic seal enclosure (or IP67/IP68), eliminates the pin and wiring at the connector, provides positive indication of mating, and also provides early detection of a “de-mating” (which is necessary to remove power from the interface prior to contacts potentially arcing).

Accordingly, the 4-wire system may be modified into a 2-wire system to remove the two signal wires in favor of placing the EN+/EN-Return signal function on the PV+/PV− Return wires, using diode and NFET devices. A four-wire connector may still be used, but the two signal contacts would provide a wrap signal interface to simply indicate to the microcontroller that the connector is mated, thereby allowing operation to commence.

The startup sequence begins with the detection of a connector mate. The solar side operates using power from the PV panels but does not provide PV power output initially. Instead, the system waits for a startup signal from the controller. During this waiting period, the solar side may provide an advertisement output voltage to indicate the presence of solar panel power. Concurrently, the controller side operates on battery power and waits for a “cable connected” signal wrap before issuing the EN+ output on the PV+/Rtn signal pair. The controller decides to provide a 24 VDC EN+ output based on observing the advertisement, a time-of-day function, or periodically, and then waits for a response. Upon observing the current pulse response, the controller provides the power (voltage level signal) and waits to receive the PV+ power level.

Once the solar side receives the EN+ signal, the system performs a startup built-in test and sends capability and status data via current pulsing. The system then waits for a period to receive the EN+ voltage indicating the required power level. Upon receiving this signal, the solar side configures the PV relay/FET combination to provide the required output power level. After transmitting PV+ to the controller, any cable disconnect, requested disconnect, or fault will result in the immediate cessation of PV+ power. From the controller side, opening the power FETs to the Maximum Power Point Tracking (MPPT) will result in zero current, which will be observed by the solar side and will immediately initiate a FET and relay open (off) transition. From the solar side, detection of a fault, loss of load current, or cable disconnection will result in power being turned off and a transition to standby mode, where the solar side microcontroller will continue to operate on solar power.

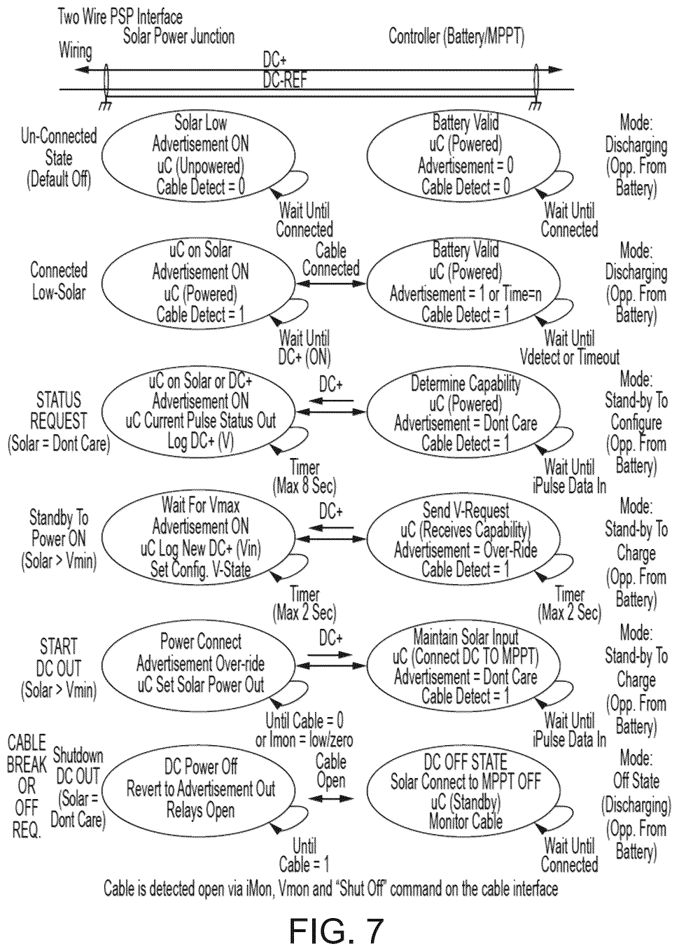

FIG. 7 illustrates the transitions for the two-wire option (Type 3). The functions of the 4-wire Type 2 PSP system may be implemented on a two-wire interface, as demonstrated by the 2-wire Type 3 PSP system (FIG. 6). This implementation supports several key functionalities. Firstly, the system powers off when an open connection or wiring integrity issue is detected. The startup process follows a specific sequence: the PV side provides a sampling output of solar power, which is 15V or less and set to half the maximum capability of the PV system. The MPPT controller then provides a startup signal of 24 VDC±2 to initiate the PV side cable integrity checking and startup operation of local PV power. Within eight seconds of startup, the PV side completes a built-in test and communicates its capability and status to the MPPT/controller side of the interface. The MPPT/controller responds by setting the output voltage to the requested level, which could be 24V (no change), 48V, or 72V. Subsequently, the PV controller registers the input voltage and enables the NFET and Relay to provide PV output power.

Each controller, both on the PV side and the MPPT side, implements a diode output sourcing mechanism. This allows either side to drive a higher DC voltage to provide signaling and power. Communication between the two sides is achieved via current pulsing at startup. The PV side controls a load using a power FET and resistor to pulse a differential current loading of the source power, which is detected at the MPPT controller side.

Fault detection is another feature of this implementation. If a fault is detected on either side, the system returns to startup mode, characterized by low voltage or zero voltage on the wired interface. An open wire or disconnect is detected through a wrap signal at each disconnectable side. Additionally, ground faults or sudden current losses of the load are detected at the PV side, prompting a return to standby mode, also known as advertisement mode.

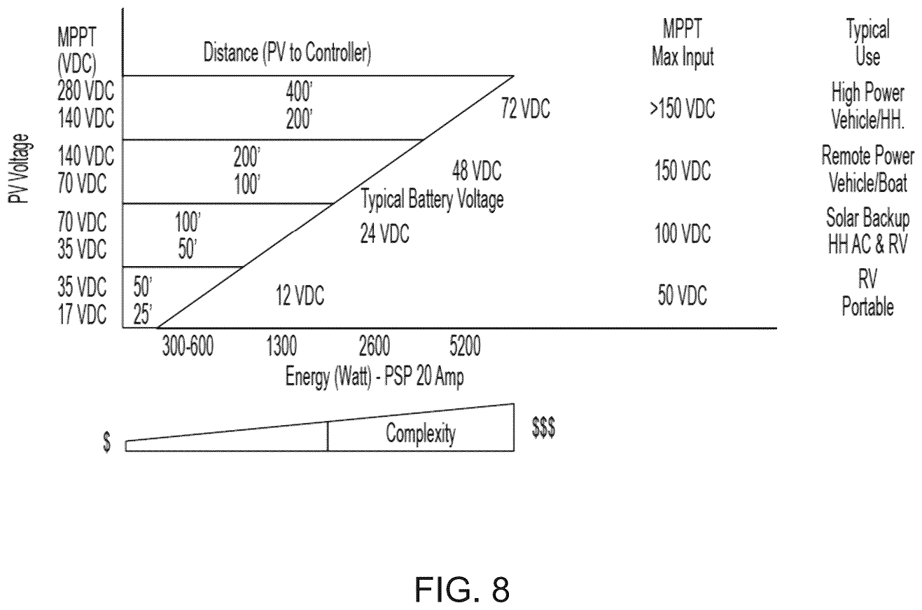

FIG. 8 illustrates the trade-offs of cost/complexity versus power level and distance. The Type 1 PSP system may be lower cost and may be ideally suited for a 35V PV system with 12 or 24 VDC batteries. The 35V MPPT point, achieved with two solar panels in series, operates below the 50 VDC threshold for RV power and above the 30 VDC OSHA safety threshold. This system features a controller with a battery power output (to EN+), and the panels provide intrinsically safe DC output after verifying cable integrity, offering a cost-effective solution with a capacity of 600 W and a maximum distance of 50 feet.

For a medium-cost threshold, the Type 2 PSP system may be applied to 35V, 70V, and 140V solar panel designs, supporting power transfer up to 2600 watts over distances up to 200 feet. These systems should include junction boxes and controllers equipped with full diagnostics and configuration capabilities, and they may utilize either a 4-wire or a 2-wire design.

Operating PV voltages of 140 VDC (MPPT Point) and above necessitates the use of four or more panels in series, with optimal performance achieved when all panels receive equivalent levels of sunlight. For example, an eight-panel configuration can provide 1.6 kW and requires 900 square feet of surface area, while a 3.2 kW configuration, consisting of 16 solar panels arranged in an 8-series by 2-parallel setup, requires 1800 square feet. This setup will necessitate multiple panel-to-junction box interfaces, some extending beyond a 10-foot reach for optimal arrangement. Consequently, this application is more suited for permanent installations such as carports, industrial building rooftops, or infrastructure projects where loads may intermittently connect to the system. For instance, a rooftop solar array on a building could supply PV energy directly to an electric car or serve as an offset and backup power system for the home grid. When a pluggable load is connected, the system prioritizes directing energy to this new load, while establishing the appropriate series or parallel configuration of panels optimized for the new load. Once the temporary load is disconnected, the PV configuration is reverted to the default series configuration, and the energy should automatically revert to the default load to maintain cost-effectiveness.

Higher levels of output power increase the risk of harmful voltages causing unwanted consequences. Therefore, the systems described herein transferring 2 kW or more may include additional fault monitoring. This includes monitoring individual relay contacts, solar panel interface voltage, individual series path currents, and the operation of each power control device.

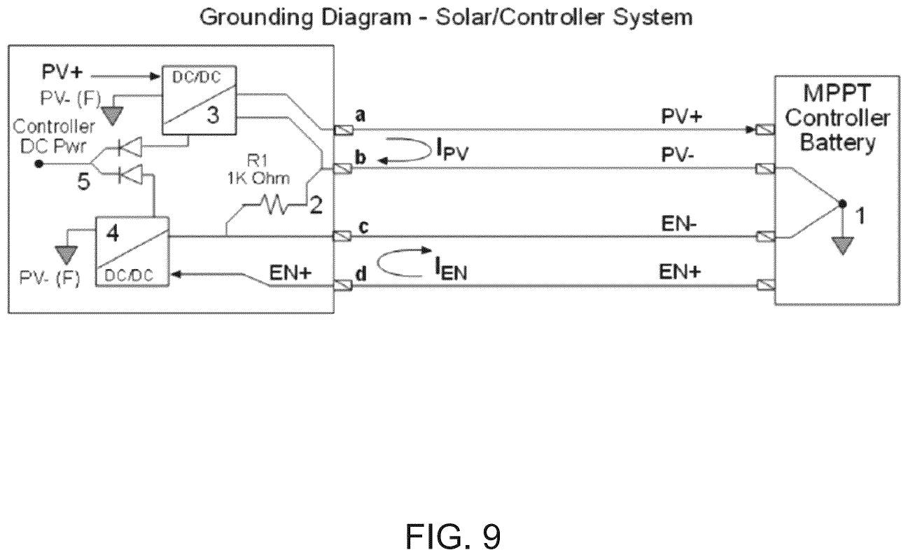

FIG. 9 illustrates an exemplary grounding configuration for the PSP system, specifically focusing on the MPPT controller side. The diagram highlights several key components and their functions. Firstly, it shows the common ground connection of PV− and EN− at the MPPT controller side. This common ground is essential for maintaining system stability and ensuring accurate fault detection. A static connection resistor, R1, provides weak bonding between the grounds and supports the detection of open connector pins. Additionally, a DC/DC power converter, which sources power from the solar panels, supplies power to the controller and relay coils within the junction box circuits. This setup enhances power efficiency and provides a PV-referenced ground, which provides accurate analog detection of individual solar panel voltages, overall current, and ground faults in the power output path (I_{PV}). Furthermore, a DC/DC isolated power converter ensures the startup and operation of the microcontroller when solar energy levels are low. Lastly, a diode OR power configuration supports the controller's power requirements.

The standard grounding configuration on the MPPT/Controller side involves connecting PV− and the Battery terminal (−) together. This singular ground at the MPPT/Controller detects ground faults along the energy transfer path. The system employs a separate two-wire path (EN+ and EN− Return) to provide a safe initial voltage that wakes up the solar panel processor and initiates the startup sequence. If the controller requests a PV voltage under 50 VDC, such as from a 12 or 24V battery, the EN+ source remains unchanged, and the solar panel energy is sourced on PV+ with respect to PV−. For higher PV voltages, the EN+ voltage may increase to higher levels (48V, 72V) after verifying cable connection integrity.

FIG. 9 also depicts the PV junction box/controller on the left side, showcasing an isolated ground design where PV current (I_{PV}) returns on the power wire (PV−) and startup power (EN+) returns on EN−. The controller employs a high impedance tie (R1 at, for example, 1K Ohms) that provides a static reference between the grounds and supports rapid current fault detection. This design is crucial for detecting cable removal or cable faults. For instance, during cable removal, one of the four pins (a, b, c, d) will open its connection first. If contact (a) opens first, a sharp current drop is detected from either side (PV or MPPT), resulting in a power-off via NFET and Relay opening on the PV side and EN+ removal from the MPPT side. If contact (b) opens first, a large voltage spike across R1 is detected by the PV side controller, leading to NFET and the relay opening. Similarly, if contact (c) opens first, the isolated DC/DC converter shuts down resulting in a power failure signal (P-FAIL) assertion leading to the NFET and the relay opening. If contact (d) opens first, a voltage drop of EN+ occurs, also resulting in power failure assertion leading to the NFET and the relay opening.

The DC/DC power topology in the solar panel controller utilizes a PV− ground reference with most of the circuit loading directly on the PV output. This configuration results in a minimal load on the EN+ side, making it straightforward to use EN+ (with EN-RTN) for current pulsed communication during startup. This design supports built-in testing capabilities, ensuring reliable operation and fault detection within the system. The EN+ wire facilitates startup signaling to initiate built-in tests and provide PV+ output according to the configuration signaled on PV+. It also supports static loading and bracketed testing with discrete output to brackets (12V, 24V, 48V, 72V), providing configuration signals for PV+ output voltage levels. The interface and control are simplified via opto-isolation to maintain ground isolation across EN-RTN and PV−.

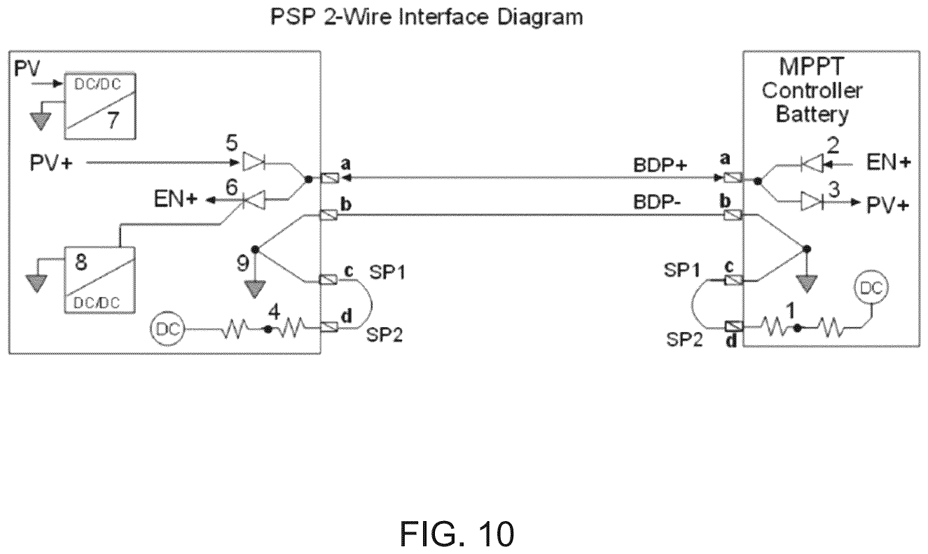

FIG. 10 illustrates an exemplary PSP 2-wire interface diagram, depicting connector contacts (a, b, c, d) at each end of the interface. The power contacts (a, b) are designed to be longer than the signal contacts (c, d), ensuring that the power contacts engage first when the connector is mated and disengage last when disconnected. The system negotiates power transfer on a single wire pair, which provides a cost-reducing measure for wiring.

The 2-wire PSP implementation retains all the features and capabilities of the 4-wire design, including intrinsic safety when disconnected, current pulse communication of capabilities and status at power-up, and cable disconnect detection with instant power off via an NFET/Relay at the PV source side. Despite using reduced wiring, it maintains a common return signal feature (BDP−), as shown in FIG. 10.

The signals and power are defined as follows: BDP+ represents Bi-direction Power+, which serves as the EN+ source into the PV side at startup and as the PV+ source to the MPPT Controller after successful completion of a Built-in Test and communication of status via current pulsing. Although not shown in FIG. 10, the current pulse standard load and NFET may be connected. BDP− represents Bi-direction Power-(Return), used as the DC reference. BDP− is isolated from the chassis on the PV solar side but is connected to chassis ground (single point) after the ground fault detection circuit on the MPPT side.

Short pin 1 (SP1) and short pin 2 (SP2) form the connector detection signal loop. Alternatively, magnetic proximity sensing may instead be used for the connector detection signal loop. A low voltage DC source provides a voltage drop over resistors (1 and 4), with return coupling from SP2 to SP1 to BDP−, creating an easily sampled voltage signal for cable mating detection. Upon detecting cable disconnection, each side of the interface will cease power transfer and loading, resulting in zero current on BDP+ followed by near-zero voltage.

The diagram includes diodes (2, 3, 5, and 6) to illustrate the direction of current flow. The system may utilize diodes, NFETs, and/or smart ORing Diodes. The system defines startup timing and voltage levels for signaling, allowing for straightforward control of semiconductor devices to load and unload the BP+ line. Any loss of power or fault will result in the removal of PV+ power on BD+ and a return to the startup state for the controllers.

FIG. 11A illustrates a method that eliminates the need for short contact pins in the interface, thereby removing the necessity for a loop wire in the plug. This is achieved by incorporating a small magnet into the plug's rotating tri-lock ring and positioning a magnetic flux sensor below the fully mated lock position of the magnet. This configuration allows for the detection of positive mating, which is then signaled to the control system. The alignment of the magnet and the Hall effect sensor (i.e., the magnetic flux sensor) uses a flux guide, if necessary, to ensure that the sensor's “mated” signal is active only when the receptacle/plug contacts are fully inserted. Since the PSP system only requires the detection of the un-mating action to disable power before plug removal, this magnetic method offers a reliable and cost-effective solution for standard connector implementation.

The control circuit function for a two-wire PSP with magnetic “mate” detection may operate as follows: Initially, the cable is unpowered and not connected to the receptacle. The user then installs the cable and rotates the tri-lock ring to the mated and locked position. The magnetic flux provides a “mated signal,” but the interconnect remains unpowered (i.e., not above 30V). The control side then sends a startup voltage signal to the solar side. The solar side performs a startup built-in test, verifies the magnetic mate, and sends status via a current pulse over the two-wire interface. The control side receives the status and presents the power level voltage signal. In response, the solar side increases the voltage and provides the appropriate power interconnect of relay and semiconductor devices, thereby establishing the high voltage power state on the cable. This state is maintained until the controller drops the load (detected by a sudden current drop), a fault occurs, or the magnetic lock signal indicates that physical un-mating of the cable is occurring. Upon receiving an “un-mate” signal, the solar side first removes the semiconductor-based power output and then the relay contact-based power output, ensuring that the cable's power contacts are un-mated within less than 100 milliseconds. Once fully disconnected, the cable interface voltage drops below 30V.

FIG. 11B illustrates another exemplary implementation of a system for the magnetic detection of a cable mate, providing an alternative to the embodiment shown in FIG. 11A. This embodiment integrates the detection components directly into the contact alignment path of the connector, which provides for a precise and reliable indication of the connector's mating status.

The system includes a Power Cable Assembly, which terminates in a Cable Side Plug, and a Power Control Electronics Assembly, which includes a Housing Mounted Receptacle. In this example, both the plug and receptacle may use a standard connector form factor, such as a Tri-Start connector, with multiple contact positions. The diagram shows an implementation where standard socket power contacts occupy positions A, B, and C within the Cable Side Plug, and corresponding standard male power contacts are located in the Housing Mounted Receptacle.

The mate detection mechanism repurposes one of the contact positions, shown as position D. A magnet, such as a Neodymium Magnet, is installed at a fixed and precise depth within the housing of the Cable Side Plug at position D. Correspondingly, a ferromagnetic pin, such as an Iron Pin Flux Guide, is installed in the Housing Mounted Receptacle at position D. This Iron Pin Flux Guide extends from the connector interface back through the housing wall to a circuit card of the Power Control Electronics Assembly. A Hall Effect Sensor, which serves as the magnetic flux sensor, is positioned on the circuit card in precise alignment with the end of the Iron Pin Flux Guide.

During a mating operation, as the Cable Side Plug is inserted into the Housing Mounted Receptacle, the standard power contacts in positions A, B, and C engage to form the electrical connections. As the plug reaches its fully and securely mated position, the Neodymium Magnet in the plug aligns with the Iron Pin Flux Guide in the receptacle. The flux guide channels and concentrates the magnetic field from the magnet, coupling the magnetic flux directly to the Hall Effect Sensor. The detection of this concentrated magnetic field causes the sensor to generate a “mated” signal, which is provided to the system controller to confirm that a secure physical connection has been established and that it is safe to proceed with the power negotiation sequence.

The physical arrangement of the components is designed to ensure a critical safety sequence during disconnection. The relative depths of the magnet, the flux guide, and the power contacts are set so that when a user begins to withdraw the plug, the magnet moves away from the flux guide before the electrical power contacts begin to separate. This initial movement immediately opens the magnetic circuit, causing the magnetic field at the Hall Effect Sensor to drop below its detection threshold. The sensor de-asserts the “mated” signal, providing an early “un-mate” warning to the controller. Upon receiving this signal, the controller instantly initiates the power-down sequence, deactivating the power FETs and then opening the power relay. This entire power-down process is completed in the brief interval before the power contacts physically disengage, thereby ensuring that power is removed from the contacts prior to their separation and preventing the possibility of electrical arcing.

FIG. 11C provides a cross-sectional view of the magnetic mate detection system embodiment of FIG. 11B, illustrating the physical relationship of the components and the path of the magnetic circuit when the Cable Side Plug is fully mated with the Housing Mounted Receptacle. This view further clarifies how the system achieves a reliable and precise indication of the connector's status.

The diagram shows the standard male power contacts of the receptacle fully engaged with the standard socket power contacts of the plug. In the dedicated mate detection position, the Neodymium Magnet, which is seated within the Cable Side Plug, is shown in close proximity to the end of the Iron Pin Flux Guide, which is seated in the Housing Mounted Receptacle. The representative Magnetic Flux Lines illustrate the operation of the magnetic circuit in this mated state. The flux lines emanate from the magnet, are gathered and channeled by the low-reluctance path of the Iron Pin Flux Guide, and are coupled to the Hall Effect Sensor located at the distal end of the guide pin within the Power Control Electronics Assembly. The length of the Iron Pin Flux Guide, which may be two to three inches, is sufficient to pass through the connector housing and reach the circuit board while providing adequate clearance behind the receptacle for the required bend radius of the power conductors.

This embodiment provides several advantages. By repurposing existing contact cavities within the standard connector housings for the magnet and the flux guide, the system leverages the inherent dimensional precision of the connector for X-Y alignment. Similarly, the standard internal detents and shoulders within the connector housings provide precise Z-axis alignment, controlling the depth of the components and the resulting gap between the magnet and the flux guide pin when mated. This allows for the implementation of the mate detection system with little or no modification to the base connector design. The use of the flux guide creates a simple and robust method for aligning the magnetic field with the Hall Effect Sensor. The rapid change in magnetic flux that occurs as the small air gap is closed during mating or opened during de-mating, combined with the inherent electrical hysteresis of the Hall Effect Sensor, results in a dependable and clean digital “mated” signal with minimal risk of intermittent or false signaling.

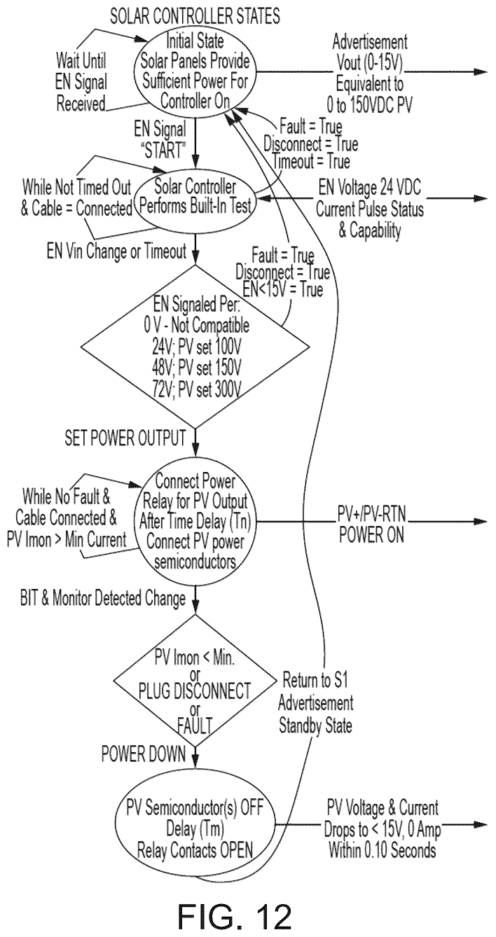

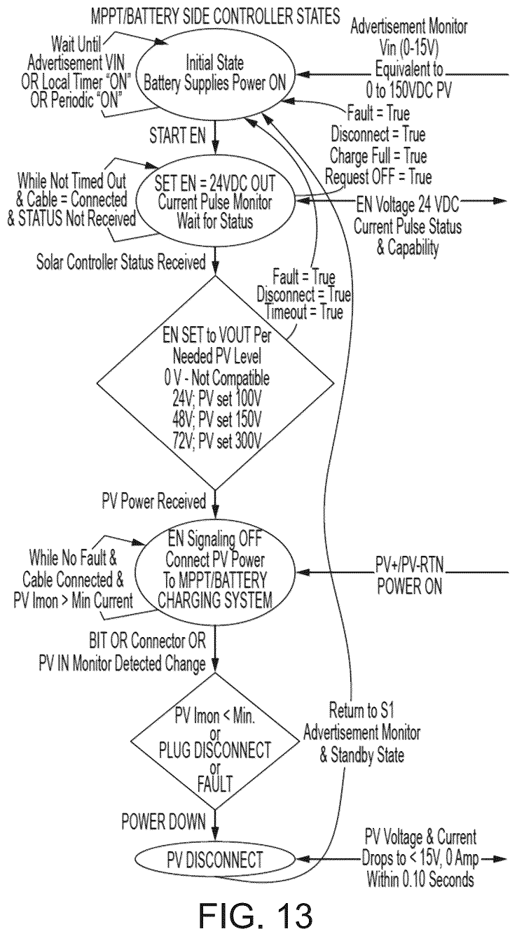

Both the solar and controller sides may conduct tests on the relay state, semiconductor states, voltage, and/or current in the power circuit to ensure that no latent faults are present or undetected, which could pose a hazardous condition on the wiring interface or to a user. The states of the solar side controller and MPPT/battery side controller are depicted in FIGS. 12 and 13 apply to both the 4-Wire and 2-Wire configurations of the PSP interface.

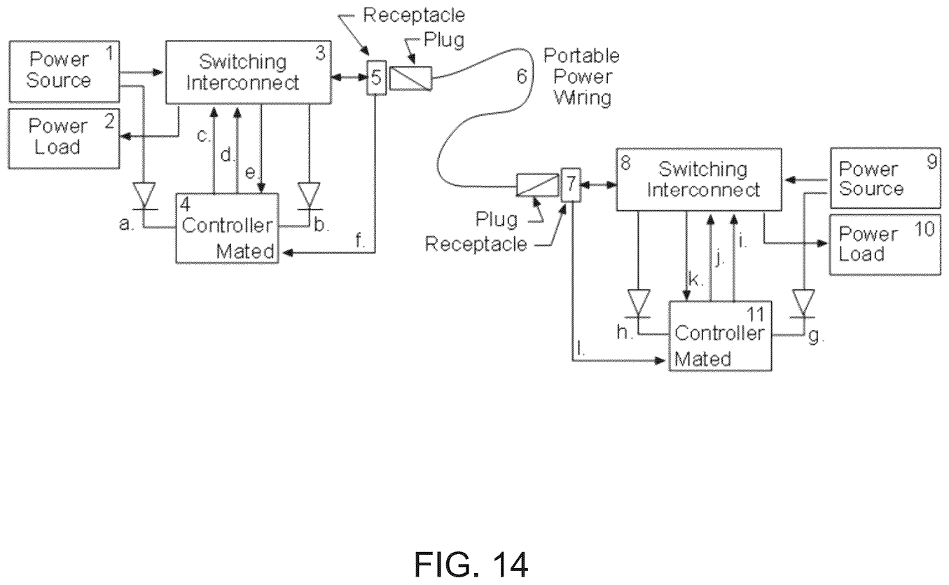

FIG. 14 illustrates a generalized block diagram of a communicated and intrinsically safe power distribution system, expanding upon the principles previously described in the context of solar power to encompass a broader range of applications. This generalized system can be understood by mapping its components to the specific solar power embodiment previously described. For instance, the Power Source 1 of FIG. 14 corresponds to the solar panels. The functional block on the first system end, comprising the switching interconnect 3, controller 4, and receptacle 5 in FIG. 14, corresponds to the PPS or PSP Junction Box of the solar embodiment. The portable power wiring 6 of FIG. 14 corresponds to the PPS or PSP Interface, and the functional block on the second system end, comprising the receptacle 7, switching interconnect 8, and controller 11, corresponds to the PPS or PSP Controller. Finally, the power source 9 and power load 10 of FIG. 14 represent the functions of the energy storage system and the DC/AC appliance loads. This system facilitates the safe, negotiated, and pluggable transfer of power, which may be AC or DC, between two system ends.

In some implementations, the system includes a first system end, which includes components such as a power source 1 and a power load 2. It is understood that a given system end may include only a source, only a load, or both. For example, in the context of a solar panel array, the first system end would primarily include a power source 1 (e.g., the photovoltaic panels). In the context of a battery energy storage system with an inverter, it may include both a power source 1 (the discharging battery/inverter) and a power load 2 (the charging battery). The first system end further includes a switching interconnect 3, which is responsible for physically connecting or disconnecting the power source 1 and/or power load 2 from the interface. As described previously, this switching interconnect 3 may include a combination of semiconductor devices (e.g., FETs) and mechanical relays to provide an intrinsically safe, air-gap disconnection, ensuring that no current flows during the opening or closing of relay contacts to prevent arcing.

A controller 4, which may be a microcontroller or other processor, manages the operation of the first system end. The controller 4 may receive power from a plurality of inputs to ensure fault tolerance and redundancy, as shown by power inputs a. and b. The controller 4 manages the switching interconnect 3 via control signals c., and it communicates and detects faults over the power interface via signals d. and e. The first system end connects to a portable power wiring 6 via a pluggable connector, such as a receptacle 5. A safety feature is the “mated” signal f., which provides a definitive indication to the controller 4 that the receptacle 5 is fully and securely connected to the portable power wiring 6. This mated signal f. can be generated by various means, including the use of short and long contact pins as described in relation to FIG. 10, or through non-contact methods such as the magnetic proximity sensor described in relation to FIG. 11A.

Similarly, a second system end includes a corresponding set of components. These include a power source 9, a power load 10, a switching interconnect 8, and a controller 11. The controller 11 receives redundant power via inputs g. and h., controls its switching interconnect 8 via control signals i., and communicates via signals j. and k. The second system end connects to the portable power wiring 6 via a pluggable connector 7, and receives a mated signal l. from the connection to inform the controller 11 of a secure physical link. The portable power wiring 6, which may comprise at least two wires for power transfer, serves as the physical medium for both power and communication between the two system ends.

The operational logic of the communicated power interface ensures safety at all stages, beginning from an unconnected state. In a first state, when the portable power wiring 6 is unconnected or the system is powered off, the receptacles 5 and 7 are designed to be intrinsically safe. Any voltage present on the contacts is limited to a safe level, for example, a maximum of 30 VDC, with current limited to a maximum of 25 mA, in compliance with OSHA standards. This low-power signal may serve as an “advertisement” or a wake-up signal, indicating to a device being connected that a compatible interface is present, as previously discussed.

Upon connection of the portable power wiring 6 at both ends, the mated signals f. and l. transition to a true or active state, informing their respective controllers 4 and 11. The controller of the device that was last connected, having observed the advertisement signal from the other end, may then respond by elevating the voltage on the interface to an “Enable” signal level, for example, up to 60 VDC with a current limit of 1 ampere. This Enable signal has sufficient power to reliably operate the controller at the opposite end, ensuring that both controllers are active and ready to manage their respective switching interconnects and communicate.

Once both controllers 4 and 11 are powered and aware of a secure connection, they verify the integrity of the cable interface. This verification can include tests such as measuring impedance between the power lines and a ground or earth connection, which is particularly relevant when operating on a two-wire interface, to detect faults.

Following the integrity check, the controllers 4 and 11 engage in a negotiation protocol to determine the nature of the power transfer. The capability, status, and power needs of each end are communicated over the power interface itself, using the Enable signal as a carrier. The physical layer for this communication may use amplitude modulation and/or current loading modulation, while the protocol layer may use techniques like pulse width modulation (PWM). A device that is only capable of sourcing power (e.g., a simple solar panel junction box) is required to modulate current on the signal to transmit data and receive data by demodulating voltage amplitude. Conversely, a device only capable of receiving power (e.g., a simple load) modulates voltage to transmit and demodulates current to receive. A device with bi-directional capability, such as a battery/inverter system, is required to have both voltage and current modulation and demodulation capabilities. For example, if the first system end is a battery system indicating a low state of charge, and the second system end is connected to the AC grid, the negotiation would establish that power should flow from the grid (source 9) to charge the battery (load 2).

Once the direction, type (AC/DC), and parameters (e.g., voltage level) of power flow are successfully negotiated, the controllers 4 and 11 command their respective switching interconnects 3 and 8 to configure the power path accordingly within a predetermined time frame. Power transfer then commences and continues until a terminating condition occurs. Such conditions include: a de-mating event signaled by the mated signals f. or l.; an indication from the power source that it needs to cease transmission; a request from the power load to cease; the detection of a wiring or control fault (e.g., ground fault, arc fault, over-voltage, over-current); or, in a 4-wire interface embodiment, the removal of the Enable signal.

If the need to terminate power is detected at the source end (e.g., by controller 4), its switching interconnect 3 opens the circuit, removing power from the interface. The controller 4 then monitors the interface until the voltage returns to a safe level (e.g., <30 VDC). If the termination is initiated by the load end (e.g., by controller 11), its switching interconnect 8 will open. In one embodiment, to ensure the source also ceases transmission rapidly, the load controller 11 may intentionally and safely induce a momentary, detectable condition, such as a temporary ground fault, which is immediately detected by the source controller 4, signaling it to turn off its power supply.

After power down is confirmed by detecting a voltage below the safe threshold on the interface for a minimum period, one or both ends may re-establish the low-power advertisement signal. This returns the interface to its initial, intrinsically safe state, ready for a new connection and negotiation sequence.

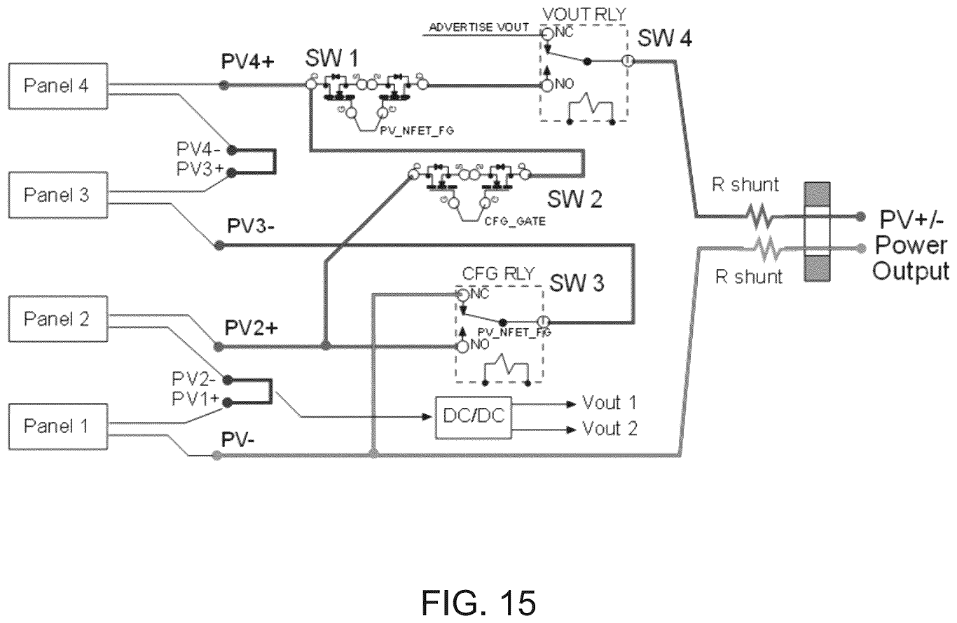

FIG. 15 provides a detailed circuit diagram of a configurable Type 2 PPS junction box, illustrating one implementation of power control for a four-panel photovoltaic power supply. This circuit enables the aggregation of power from multiple solar panels (Panel 1, Panel 2, Panel 3, and Panel 4) into various series and parallel configurations to meet the negotiated power requirements of a connected charge controller, as discussed in

sections such as and [0050]. The circuit employs a combination of semiconductor switches and electromechanical relays to achieve flexible and safe power routing.

The circuit includes four solar panels, which are interconnected via a switching network comprising two sets of back-to-back N-Channel MOSFETs, SW 1 and SW 2, and two Single Pole Double Throw (SPDT) relays, SW 3 (CFG RLY) and SW 4 (VOUT RLY). The back-to-back MOSFET configuration of SW 1 and SW 2 allows them to block current in both directions when in an off state, providing robust semiconductor-based switching. A local DC/DC converter, powered by the series combination of Panel 1 and Panel 2 (connected between PV− and PV2+), provides regulated voltages (Vout 1, Vout 2) to power the coils of relays SW 3 and SW 4. The gate drivers for the MOSFETs SW 1 and SW 2 (controlled by signals PV_NFET_FG and CFG_GATE, respectively) are powered by the EN+ signal received from the system controller, ensuring that high-power switching only occurs upon an explicit command after the interface integrity has been verified. The final power output (PV+/− Power Output) includes series shunt resistors (R shunt) on both the positive and negative lines to facilitate current monitoring for control and fault detection purposes.

In a default, unpowered state, relay SW 4 is de-energized, connecting its common terminal to the normally closed (NC) contact. This routes the potential voltage from the panel array, through the non-conductive SW 1, to an ADVERTISE VOUT line. This corresponds to the advertisement mode, where a safe, low-power signal indicating the availability and approximate voltage of solar power is presented to the charge controller before a full power connection is established.

Following a successful negotiation between the junction box and the system controller, the switching devices are set to one of several power-on states. The control logic ensures a safe switching sequence, where relays are actuated first to establish the desired path (dry switching), followed by the activation of the MOSFETs to allow current to flow, thereby preventing arcing at the relay contacts.

One possible configuration is a full series output, which maximizes the output voltage and minimizes resistive power losses in the wiring. In this state, the controller energizes the coils of SW 4 and SW 3, causing their common terminals to connect to their normally open (NO) contacts. SW 3 connecting to its NO contact routes the positive terminal of Panel 2 (PV2+) to the negative terminal of Panel 3 (PV3−), placing all four panels in a single series string. SW 2 remains open (non-conductive). After the relays have settled, the controller activates SW 1, completing the circuit from the positive terminal of Panel 4 (PV4+) through SW 1 and the NO contact of SW 4 to the PV+ Power Output terminal. The resulting output is the sum of the voltages from Panel 1 through Panel 4, with a current equal to that of a single panel.

Another configuration provides a parallel output at half voltage and full power, which may be suitable for charge controllers with a lower maximum input voltage. In this state, SW 4 is energized (connecting to NO) and SW 3 is de-energized (connecting to NC). The NC connection of SW 3 connects the negative terminal of Panel 3 (PV3−) to the main negative rail (PV−). The controller then activates both SW 1 and SW 2. This creates two parallel strings of two series-connected panels: the first string comprises Panel 1 and Panel 2, with its output at PV2+ routed through SW 2 to the common positive line; the second string comprises Panel 3 and Panel 4, with its output at PV4+ routed through SW 1 to the common positive line. The combined current from both strings is delivered via SW 4 to the PV+ Power Output. This configuration provides a voltage equivalent to two series panels but with twice the current of a single panel.

The system can also be configured for a half-power output, for example, during lower solar irradiance or when the load requires less power. This can be achieved by using only the second string of panels (Panel 3 and Panel 4). The switch settings are similar to the full-power parallel configuration (SW 4 energized to NO, SW 3 de-energized to NC), but with SW 2 remaining open. With SW 2 open, the string comprising Panel 1 and Panel 2 is disconnected from the output. Only SW 1 is activated, delivering power exclusively from Panel 3 and Panel 4 to the PV+ Power Output.

This configurable topology provides significant safety features. High-voltage series connections are only formed electronically after the entire system is physically connected and its integrity is verified, preventing exposure to hazardous voltages on any open connectors during installation. The ability to select between half-voltage and full-voltage outputs allows the junction box to adapt to a wider range of MPPT controllers and battery systems, enhancing interoperability. Furthermore, the integrated current monitoring via the R shunt resistors provides critical feedback to the controller for implementing fault detection, such as ground fault or over-current conditions, and for ensuring that the output current remains within the safe limits of the portable power wiring.

FIG. 16 illustrates an exemplary circuit implementation for the supply-side of the Two Wire Current-Voltage-Power (TWIVP) interface, such as may be used within a solar panel junction box. This circuit is designed to achieve the bidirectional communication previously described, enabling the reception of data via amplitude demodulation (RX) and the transmission of data via current modulation (TX) over the EN+ and EN_RTN signal pair.

The circuit receives its primary operational and wake-up power from the EN+ Supply (a), which is provided by the system controller at the other end of the interface and may range from 0 to 98 VDC. This incoming power on the EN+ and EN_RTN lines is directed to a set of DC/DC converters. An RC filter, comprising resistor R1 and capacitor C1 at node e, provides decoupling for the DC/DC converters and helps improve the slew rate of the modulated current pulses. The DC/DC converters are rated for a high input voltage, for example 100 VDC, and produce a regulated logic supply voltage, P4V5 (g), for example at 4.5 to 4.8 VDC. This regulated voltage P4V5 is referenced to the local ground, PV-LGND, and powers the microcontroller and other logic-level components. One of the converters is an isolated DC/DC converter which generates a POWER GOOD signal (i). This signal serves as a wake-up indicator to the microcontroller, signaling that the EN+ supply is active and stable, thereby prompting the microcontroller to exit an idle state and begin the power-on negotiation sequence. To ensure fault tolerance and operational capability even when the EN+ supply is not present (e.g., before connection), the circuit may also draw power from a local source, such as the solar panel output PV1 (f). The local supply and the EN+ derived supply are combined in a diode-OR configuration to provide a continuous and reliable power source for the circuit's control logic.

For receiving data (amplitude demodulation), the circuit must safely and accurately measure the voltage of the EN+ line. An isolation amplifier (b) is used to sample the EN+ voltage. The isolation amplifier provides an output signal that is an accurate representation of the EN+ voltage but is safely referenced to the local logic ground (PV-LGND). This isolated signal follows two paths. The first path provides an analog signal Vm (l) to an analog-to-digital converter (ADC) input on the microcontroller, allowing for precise measurement of the EN+ voltage level. The second path feeds the isolated signal to one input of a comparator. The other input of the comparator is connected to the output of an 8-bit digital-to-analog converter (DAC). The microcontroller sets the threshold voltage for the comparator by writing a value to the DAC via a standard communication bus such as I2C or SPI (o). The DAC uses a stable analog voltage reference, Analog Vref 3.0 (h), which is also provided as a reference to the ADC (n). The output of the comparator (m) is a logic-level digital signal that indicates whether the EN+ voltage is above or below the threshold set by the DAC. This digital signal is fed to the microcontroller, representing the demodulated data received from the system controller.

For transmitting data (current modulation), the microcontroller generates controlled current pulses on the EN+ line. This is achieved using two parallel PFET-driven resistive loads (c, d). Each PFET is connected in series with a resistor, and the combination is connected between the EN+ and EN_RTN lines. The first PFET circuit (c) is designed with a resistance suitable for creating a detectable current load when the EN+ supply is in a lower voltage range, for example from 9 to 30 VDC. The second PFET circuit (d) is designed with a different resistance suitable for the higher EN+ voltage range, for example from 31 to 98 VDC. The microcontroller activates these loads using discrete output signals iPulse (Lo) (j) and iPulse (Hi) (k), respectively. By briefly turning on the appropriate PFET, the microcontroller creates a momentary current draw on the EN+ line. This current pulse is detected by the system controller at the other end of the interface as a transmitted data bit.

FIG. 17 illustrates an exemplary circuit for the controller side of the TWIVP interface, such as may be implemented within an MPPT/charge controller. This circuit is the counterpart to the supply-side circuit shown in FIG. 16 and is designed to receive data via current demodulation (RX) and transmit data via amplitude modulation (TX). The entire process is managed by a microcontroller (k), which is powered by a local source such as a battery or an AC/DC input.

The circuit provides and modulates the voltage on the EN+ line to transmit data. It includes two selectable voltage sources. The first is a low-voltage source, for example a 12 VDC output, provided by a DC/DC converter (e). The second is a higher-voltage source, V+ (DC), which may be the main battery voltage. The microcontroller (k) controls which voltage is supplied to the EN+ line by selectively activating one of two PFETs, (h) and (j), via discrete I/O (DIO) signals. PFET (h) sources the 12 VDC output from the DC/DC converter (e), while PFET (j) sources the higher V+ supply. The outputs of these two PFETs are combined through a diode-OR configuration (i), which may use Schottky diodes to minimize forward voltage drop, to drive the EN+ line. An over-current limiting device (g), such as a PTC resettable fuse, is included in the output path for protection. Transmitting data is achieved by amplitude modulating the EN+ line; the microcontroller (k) enables the 12V supply via PFET (h) for a logic low state and enables the higher V+ supply via PFET (j) for a logic high state. The circuit also includes voltage monitors (Vm) at both the EN+ output (a) and the V+ supply (f) to provide feedback to the microcontroller for built-in tests, which may compare the readings to detect wiring or component failures.

The circuit receives data by demodulating current pulses drawn by the supply-side device. All current supplied to the EN+ line passes through a sense resistor Rs (a). The voltage drop across this resistor, which is proportional to the current, is measured by a current sense amplifier (b). The output of the amplifier (b) is then processed in two ways for demodulation. First, the signal is passed to an operational amplifier (c), which provides a scaled voltage signal (Im) to an analog-to-digital converter on the microcontroller (k). This allows the microcontroller to perform precise measurements of the current level.

Second, the amplified signal from (b) is fed to a comparator for digital demodulation. To accurately distinguish between high- and low-current states, the microcontroller (k) first performs a learning sequence. Upon startup, after receiving an advertisement and supplying the initial 12 VDC enable voltage, the controller expects to receive a series of calibration current pulses. During this period, the microcontroller (k) uses its ADC to measure the current levels via signal Im and calculates an average or mid-point value. The microcontroller then sets the threshold of the comparator by programming an 8-bit digital-to-analog converter (DAC) (d) via an I2C interface. The DAC, which uses a stable Vref 3.0V, outputs a voltage corresponding to this calculated mid-point threshold. Once the DAC is set, the comparator continuously compares the real-time amplified current sense signal with this threshold. The comparator's output, a digital signal labeled PWM COMM, provides a clean, logic-level representation of the received current pulses directly to the microcontroller. The microcontroller then decodes the received data by timing the transitions of the PWM COMM signal. This adaptive thresholding method allows the system to reliably demodulate the current signal despite variations in line impedance or component tolerances.

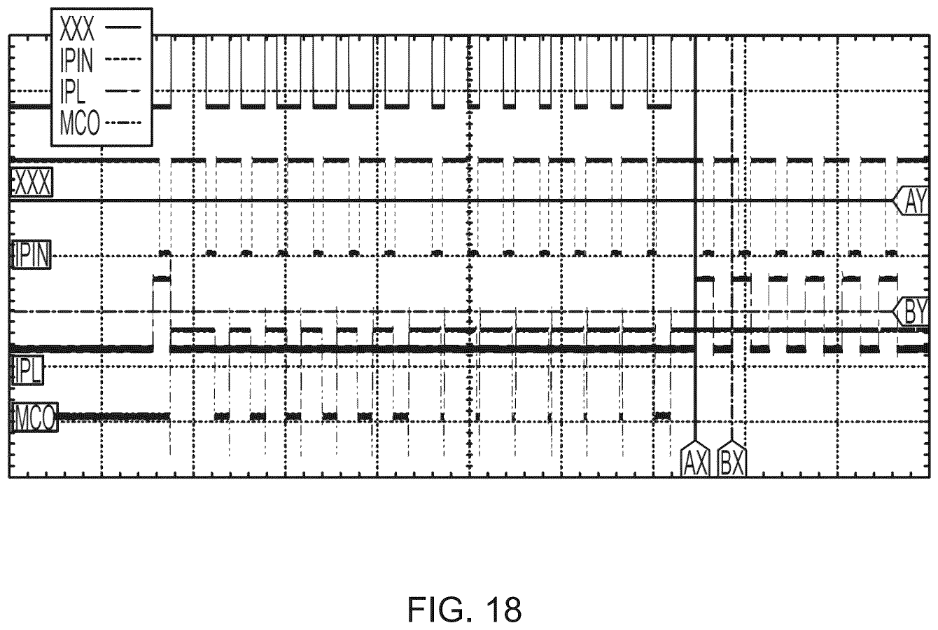

FIG. 18 is an exemplary timing diagram illustrating the bidirectional communication on the TWIVP interface after a learning sequence has been completed. The diagram shows several signal traces over time, demonstrating the simultaneous transmission and reception of data using both voltage pulse (amplitude) modulation and current pulse modulation, as implemented by the circuits described in FIG. 16 and FIG. 17.

The diagram includes four primary signal traces. The trace labeled XXX represents the voltage-modulated signal on the EN+ line as transmitted by the system controller. This signal is generated by the controller-side circuit of FIG. 17 by switching between a lower voltage (e.g., 12 VDC) and a higher voltage (e.g., V+). The trace labeled IPL represents the current drawn on the EN+ line by the supply-side device (e.g., the solar junction box). The negative-going pulses on the IPL trace are the current-modulated signals transmitted by the supply-side circuit of FIG. 16. The trace labeled MCO represents the demodulated digital output at the supply-side microcontroller, corresponding to the received XXX voltage signal. The trace labeled IPIN is another signal shown for context.

The sequence begins on the left side of the diagram, after an initial learning phase (not shown) has been completed. The system is shown in a steady state, which is terminated by an acknowledgement event, visible as a distinct pulse on the IPL signal. This acknowledgement may indicate that the learning phase was successful and both sides are ready for data communication.

Following this acknowledgement, the system controller begins transmitting data to the supply side via voltage modulation, as seen in the XXX trace. The XXX signal begins to transition between a high state and a low state in a pattern representing the data being sent. Concurrently, the supply-side circuit receives and demodulates this signal. The MCO trace mirrors the pattern of the XXX trace, with a small propagation delay, demonstrating the successful reception and demodulation of the voltage-modulated data by the supply-side circuit. The MCO signal is the digital output from the comparator in the circuit of FIG. 16, which is then read by the supply-side microcontroller.

Simultaneously, the supply side transmits data back to the controller using current modulation. This is shown by the series of negative-going pulses on the IPL trace. Each pulse represents the supply-side microcontroller briefly activating its current-sinking PFETs (as shown in FIG. 16) to transmit a data bit. These current pulses are detected and demodulated by the controller-side circuit of FIG. 17 to provide a received data stream at the system controller. The cursors, labeled AX and BY, highlight a specific time window of the communication, illustrating the timing relationship between the transmitted voltage pulses and the received current pulses. In this exemplary implementation, the communication data rate is approximately 25 Hz. In some examples, the system may support higher data rates, such as 200 Hz, with appropriate selection of circuit components.

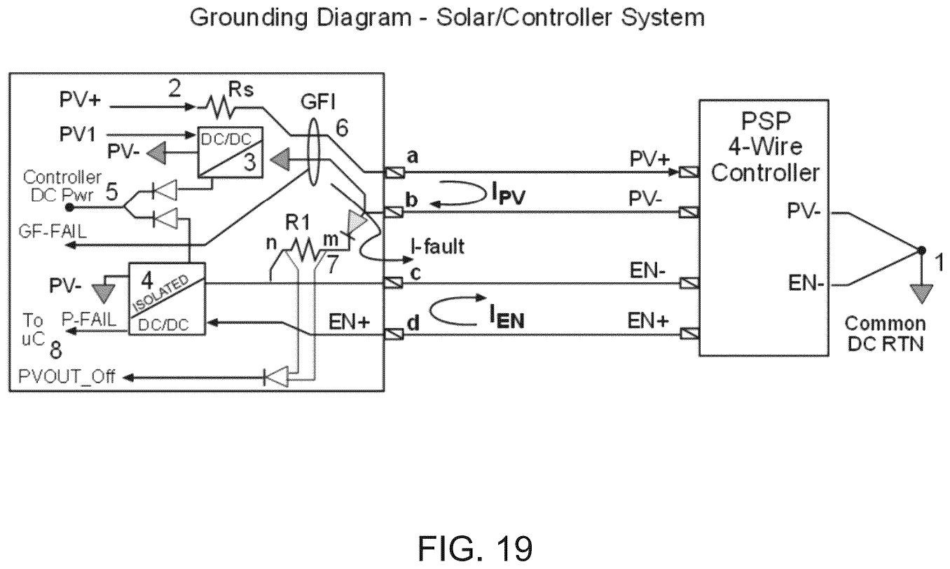

FIG. 19 illustrates a grounding and fault detection architecture for a 4-wire PPS system, detailing the circuits within the solar panel junction box (combiner) that ensure cable interconnect integrity and provide for a safe, arc-free power-down sequence. This system employs multiple, redundant mechanisms to detect various fault conditions, particularly those that may occur during the physical disconnection of the interface while it is actively transferring power.

The system architecture is based on a specific grounding scheme established by the PPS 4-Wire Controller on the load side of the interface. The controller creates a common DC return (1) by bonding the PV− and EN− lines together at a single point. This common ground at the load end is fundamental to several of the fault detection methods implemented in the junction box on the supply side.

The junction box control logic is designed for high reliability with redundant power sources. An isolated DC/DC converter (4) is powered from the incoming EN+ and EN− lines. This converter provides power to the microcontroller and the power FET switches. It also generates a discrete P-FAIL signal (8), which asserts if the EN+ supply is lost, providing an immediate indication of a fault on the enable signal lines. A second, non-isolated DC/DC converter (3) is powered from a local solar source (PV1). This converter primarily provides power to operate the coils of the main power relays. The outputs of these two power sources are combined through a diode-OR circuit (5), ensuring that the controller's DC power bus remains energized as long as either the local PV source or the external EN+ supply is available. This redundancy is critical for allowing the microcontroller to manage a safe shutdown sequence even if the EN+ power is severed.

The system incorporates several layers of fault detection. A primary ground fault interrupter (GFI) circuit (6), which may be a flux gate or current transformer, continuously monitors the differential current in the main power loop, Ipv. It measures the current flowing out on the PV+ line (contact a) and returning on the PV− line (contact b). If an imbalance exceeding a threshold, for example 30 milliamperes, is detected, it signifies that current is leaking to ground. In this event, the GFI circuit asserts a GF-FAIL signal, which provides a hardware-direct command to disable the main power FETs and is also monitored by the microcontroller.

The system is further designed to detect faults that occur during cable disconnection, where one of the four contacts (a, b, c, or d) may open before the others. If the PV− contact (b) opens first, the return path for the Ien current loop is interrupted. A dedicated fault detection circuit (7) provides an alternate, high-impedance path for this current through a diode and resistor R1 (path m to n). When current flows through this path, it creates a detectable fault current, I-fault, which asserts the PVOUT_Off signal (8). This signal immediately disables the power FETs. If the EN+ contact (d) or the EN− contact (c) opens first, the isolated DC/DC converter (4) loses its input power, causing the P-FAIL signal to assert, which likewise results in the disabling of the power FETs. If the PV+ contact (a) opens first while under load, the main power current Ipv will drop abruptly. This rapid rate of change of current (di/dt) is detected by monitoring the voltage across a current sense resistor Rs (2). A di/dt value exceeding a programmed threshold is interpreted as a disconnect or arc fault, triggering the microcontroller to instantly turn off the power FETs.

This layered approach provides redundant fault detection and ensures a safe shutdown. Each of the fault feedback signals (GF-FAIL, P-FAIL, PVOUT_Off) provides a direct hardware disable path (8) to the power FET switches for the fastest possible response, while also being monitored by the microcontroller. Upon detecting any fault, the power FETs are opened first to interrupt the flow of current. The microcontroller then commands the main power relays to open, creating a safe air gap. Because the relays are powered by the local PV source via the DC/DC converter (3), they can be held in their energized state long enough for this safe, arc-free sequence to complete, even if the EN+ power from the controller has been lost.

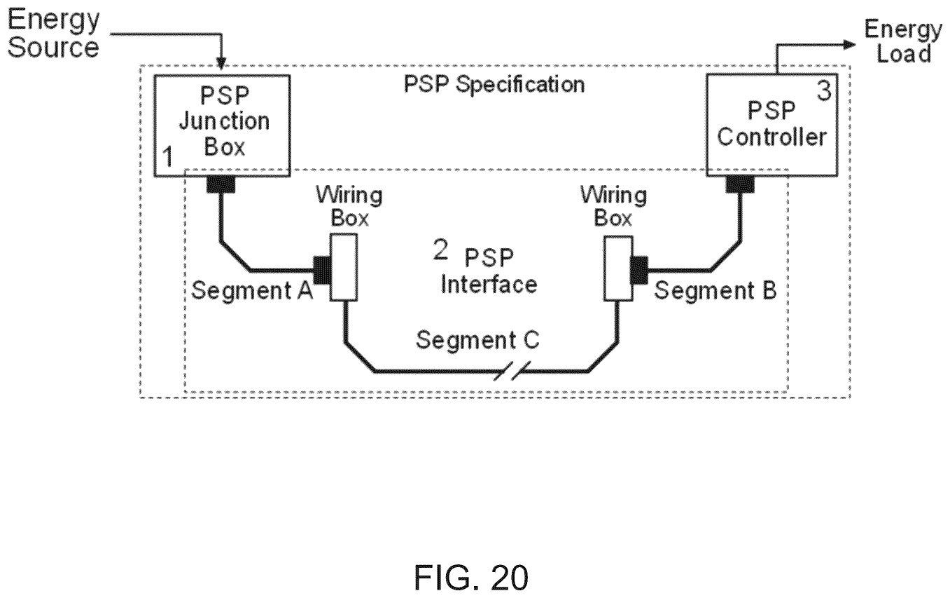

FIG. 20 provides a system-level diagram illustrating the physical wiring of a PPS implementation that supports multiple, interconnected wiring segments. This modular architecture allows for greater flexibility in installing and configuring the system in various applications, such as in vehicles, buildings, or portable power setups, where the energy source and energy load may be separated by significant distances or physical barriers.

The diagram shows an Energy Source, such as a solar panel array, providing power to a PPS Junction Box 1. The PPS Junction Box 1 connects to a PPS Controller 3, which in turn manages power delivery to an Energy Load, such as a battery storage system. The connection between the junction box and the controller is established by the PPS Interface 2. In this exemplary implementation, the PPS Interface 2 is not a single, continuous cable but is instead composed of three distinct segments: Segment A, Segment B, and Segment C.

Segment A may be a removable, flexible cable with plug-and-receptacle connectors that links the PPS Junction Box 1 to an intermediate termination point, shown as a first Wiring Box. Similarly, Segment B may be a removable cable that connects the PPS Controller 3 to a second Wiring Box. Segment C represents an intermediate wiring run that connects the first and second Wiring Boxes. This segment may be a fixed or permanent infrastructure cable, for example, wiring that is installed within the walls of a structure or the chassis of a vehicle.

This segmented architecture is fully supported by the safety protocols of the PPS specification. The system's ability to verify cable integrity, negotiate power transfer, and detect faults is designed to operate seamlessly across the entire length of the interconnected segments. A critical feature of this design is that it provides for safe, arc-free disconnection at any of the intermediate pluggable connection points. A disconnection event, whether at the PPS Junction Box 1, the PPS Controller 3, or either of the Wiring Boxes, is detected by the system's monitoring circuits. This detection triggers an immediate power-down sequence, ensuring that high-voltage power is removed from the interface contacts before they can be physically separated, thereby preventing electrical arcing and maintaining system safety.

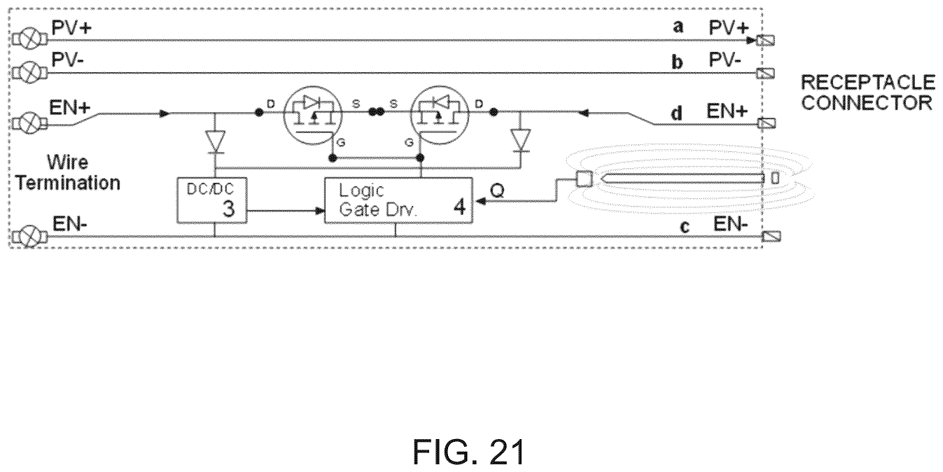

FIG. 21 illustrates an exemplary circuit for a fixed infrastructure wiring box, such as the intermediate termination points shown in FIG. 20. This circuit is designed to be placed at each pluggable interface point along a segmented wiring path, ensuring that the intrinsic safety and arc-free disconnection capabilities of the 4-wire PPS interconnect are maintained throughout the entire system.

The circuit provides a safe and intelligent pass-through for the four PPS interface lines. On the left side, direct wire terminations are provided for connecting to fixed infrastructure wiring. On the right side, a receptacle connector is provided for connecting to a removable cable segment. The main power lines, PV+ (a) and PV− (b), pass directly through the wiring box without active switching components within the box itself. The primary safety control is implemented on the enable signal path.

The EN+ signal line (d) is not a direct pass-through. Instead, it is routed through a solid-state switch, which in this example is composed of two P-channel MOSFETs connected in a back-to-back configuration. This arrangement allows the switch to block current flow in either direction when in the off state, providing a robust disconnection of the EN+ signal. The gates of these MOSFETs are controlled by a Logic Gate Driver (4).

The control logic is powered by a DC/DC converter (3) that is capable of operating at the peak defined voltage of the EN+ line. In a key design feature for ensuring operational reliability, the input to this DC/DC converter is supplied by a diode-OR configuration that draws power from the EN+ line from both the fixed wiring side and the receptacle connector side. This ensures that the logic circuit remains powered and capable of managing the switch state as long as either side of the interface is connected to an active EN+ source.

The operation of the switch is governed by a “mated” signal (Q), which is provided as an input to the Logic Gate Driver (4). This signal is generated by a magnetic proximity sensor, as represented by the magnetic field lines associated with the EN− line (c), which may serve as a flux guide as described in relation to FIGS. 11A-11C. When a compatible plug is fully inserted into the receptacle connector, the magnetic sensor detects the mated condition and asserts the signal Q. The Logic Gate Driver (4) responds by driving the gates of the P-channel MOSFETs to an appropriate saturation voltage, turning them on and establishing a low-impedance connection for the EN+ signal through the wiring box.

The critical safety function of this circuit is performed during disconnection. When a user begins to unplug the cable, the magnetic coupling is broken before the main power contacts (a, b) physically separate. This de-asserts the “mated” signal Q. The Logic Gate Driver (4) immediately removes the gate drive voltage from the MOSFETs, turning them off and instantly severing the EN+ connection within the wiring box. The main PPS Junction Box upstream detects this loss of the EN+ signal and initiates its own rapid shutdown sequence, removing high-voltage power from the PV+ line. Because of the fast response time of the semiconductor-based switch in the wiring box and the subsequent shutdown at the power source, the main power current is brought to zero before the PV+ and PV− contacts disengage. This sequence eliminates the potential for electrical arcing, which protects the connector contacts from degradation and ensures the interface is in a safe, de-energized state before the contacts are exposed. While low-cost P-channel MOSFETs are shown, in other examples, this switching function may be implemented with other low-power switching devices, such as signal relays or N-channel MOSFETs.

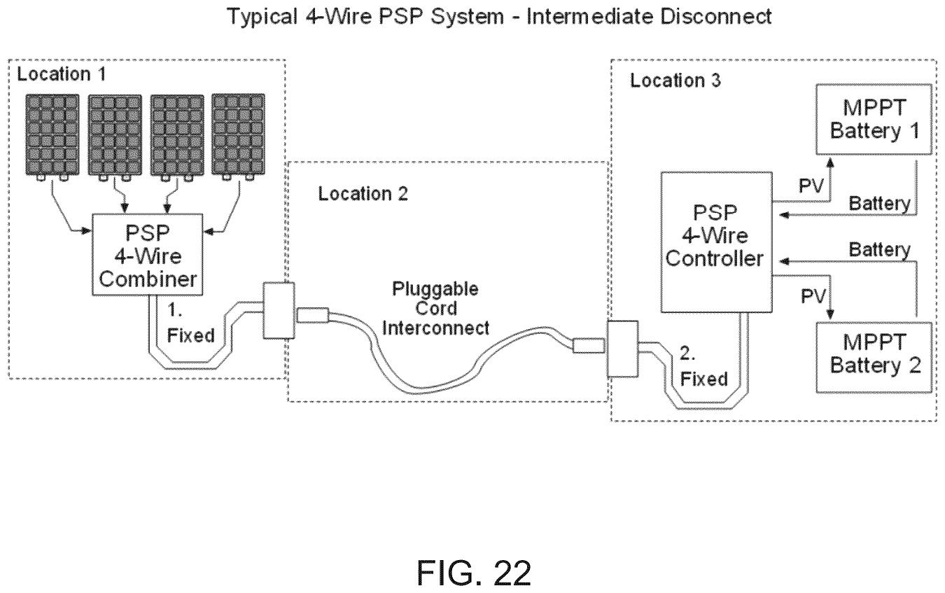

FIG. 22 illustrates a practical implementation example of a typical 4-wire PSP system, such as a solar panel array charging a system within a recreational vehicle (RV). This example demonstrates the use of a segmented wiring architecture with an intermediate disconnect to bridge separate physical locations.

The system is shown distributed across three locations. Location 1 represents a fixed installation for the energy source, such as a permanent, ground-mounted solar panel array. The power from the individual solar panels is aggregated in a PSP 4-Wire Combiner, which functions as the PSP Junction Box previously described. The combiner is connected via a fixed wiring segment (1. Fixed) to an interface receptacle that is accessible at the periphery of Location 1.

Location 3 represents the portable or mobile unit, such as an RV, which contains the energy load and storage systems. A PSP 4-Wire Controller is installed within the RV, co-located with the charging and battery devices. In this exemplary implementation, the single PSP Controller is shown managing the power distribution and charging for two separate energy storage systems, designated as MPPT Battery 1 and MPPT Battery 2. The controller is connected via a second fixed wiring segment (2. Fixed) to an accessible interface receptacle, for example, on an exterior surface of the RV.

Location 2 represents the physical space between the fixed energy source and the mobile load, which is bridged by a Pluggable Cord Interconnect. This flexible, removable cord allows a user to conveniently connect the RV at Location 3 to the solar array at Location 1 when parked, and to disconnect the cord for travel. To ensure safety across this segmented and pluggable interface, particularly in high-voltage PSP applications, each removable connection point implements the safety features described herein. The receptacles at the termination of the fixed wiring segments and the plugs at each end of the Pluggable Cord Interconnect may incorporate the intelligent disconnection circuit detailed in FIG. 21. This ensures that any disconnection event at an intermediate point triggers an immediate and safe, arc-free removal of power from the entire interface, maintaining the intrinsic safety and integrity of the overall system.

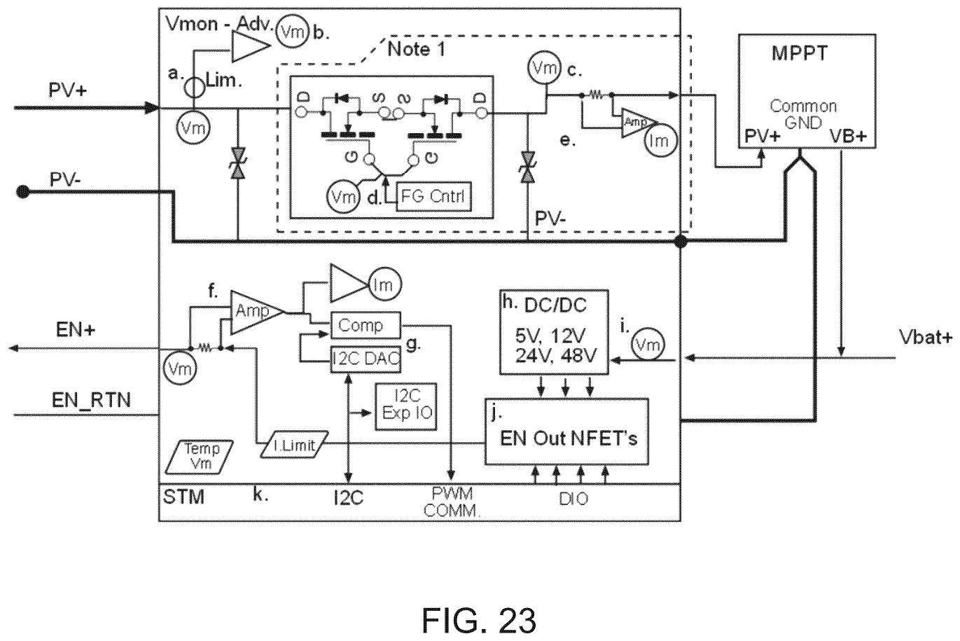

FIG. 23 provides a functional block diagram of a Smart Type II PPS Controller, detailing the internal architecture for managing both the high-power PV path and the low-power communication and control interface. This controller architecture supports advanced features, including the ability to multiplex a single solar energy source to a plurality of different loads.

The controller is organized into two main functional regions. The upper region manages the power path from the PV+ input to the PV+ output, which is connected to an external load such as an MPPT charge controller. The lower region contains the microcontroller and associated circuitry for managing the bidirectional communication over the EN+ and EN_RTN lines and for controlling the overall operation of the system.

In the upper power path region, the PV+ input from the solar panel interface is received and passed through an input limiter (a), such as a fuse or current-limiting circuit, for protection. A voltage monitor (Vm) allows the microcontroller to measure the incoming PV+ voltage. A dedicated advertisement monitoring circuit, Vmon-Adv (b), is used during the startup sequence to detect the low-voltage advertisement signal from the solar junction box, which indicates the availability of solar power. The core of the power path is a solid-state switch, shown within the dashed box labeled “Note 1.” This switch consists of back-to-back N-channel MOSFETs, which provide robust, bidirectional current blocking when in the off state. A floating gate control circuit, FG Cntrl (d), drives the gates of these MOSFETs, and its own operational voltage is monitored (Vm) to ensure proper function. On the output side of the switch, another voltage monitor (c) and a current sense amplifier (e) with its associated shunt resistor provide continuous feedback on the voltage and current (Im) being delivered to the MPPT. This monitoring allows the controller to verify that the power output remains within safe and negotiated limits. The PV− line serves as a common ground and is passed directly through the controller to the MPPT.

In the lower control and communication region, the circuit manages the TWIVP protocol on the EN+ and EN_RTN lines. The receiving (RX) function is accomplished by demodulating current pulses from the solar junction box. A current sense amplifier (f) measures the current on the EN+ line, and its output is fed to a comparator. The threshold for this comparator is dynamically set by an I2C digital-to-analog converter (g), allowing for an adaptive learning sequence to reliably decode the incoming data. The digital output of the comparator, PWM COMM, is fed to the microcontroller (k). The transmitting (TX) function is accomplished by amplitude modulating the EN+ voltage. The controller is powered by a battery voltage (Vbat+), which is monitored (i) and fed to a set of DC/DC converters (h). These converters generate the various voltage levels (e.g., 5V, 12V, 24V, 48V) required for signaling. A block of output NFETs (j), controlled by discrete I/O (DIO) signals from the microcontroller, selects and applies the appropriate voltage to the EN+ line to transmit data. The entire system is orchestrated by a central microcontroller (k), such as an STM series processor, which handles all monitoring, communication protocol management via I2C and DIO, and control logic.

A key capability of this smart controller architecture is its support for multiplexed power distribution. The entire PV+ switching and monitoring block, outlined in “Note 1,” may be incorporated multiple times within a single controller. This allows a single PV+ input from a solar array to be selectively and safely coupled to one of a plurality of different loads, such as multiple independent MPPT/battery systems, inverters, or other direct-powered equipment. In such a system, the smart controller may negotiate the optimal power output from the solar source and then, based on a pre-determined priority, system state, or user command, direct that power to the selected load by activating the corresponding NFET switch block.

Thus, the system provides a negotiated configurable solar panel output power method to ensure compatibility between the solar panel array and the MPPT charge controller. It features an intrinsically safe wired interconnect, ensuring no harmful power is present on the interface until a complete interconnected system is achieved and wiring integrity is verified at one or more levels. This intrinsic safety is achieved through the open contact of the power relay and is further enhanced by robust fault detection around the NFET-Relay power sourcing components. The system implements a novel MOSFET and Power Relay electrical design to ensure that relay contacts are not mated or un-mated with both voltage and current present, thereby overcoming the contact arcing issue that can occur when high voltage DC power is passed through a relay. This design uses a power relay within its ratings, maintaining the usable life of the relay.

Additionally, the system integrates a day/night advertisement signal to conserve power when solar energy is not available. It includes robust safety, test, and reporting capabilities with solar panel and wiring fault indications. Integrated current and voltage monitoring provide fail-safe operation, such as ground fault power-off control. The system also features multiple points of power off/disconnect for National Electrical Code (NEC) compliance. A microcontroller-based design manages timing, communications, and power state control functions, including Initiated Built-In Test at startup, continuous built-in test, voltage and current state monitoring, and status indication.

The interconnect of the junction box (JBOX) and controller in all configurable possibilities is designed to prevent equipment damage to either piece of equipment or the wiring harness. The interface design supports significantly increased cable lengths for efficient power transfer over cost-effective cable designs, minimizing copper wire gauges. A novel communications design uses a simple pulsed current method on existing power wiring, eliminating the need for additional wiring for low-rate data and enabling low-cost time-based circuits and long-distance operation. The system also includes powered cable disconnect detection by monitoring current and voltage at each end of the Power Supply Point interconnect. If a powered cable is disconnected while powered, it is detected from one or more ends, and power is immediately turned off. This detection design limits contact arcing and removes any potential safety hazards before the receptacle/plug mate is fully disconnected.

Changes and modifications in the specifically described embodiments can be carried out without departing from the principles of the invention, which is intended to be limited only by the scope of the appended claims, as interpreted according to the principles of patent law including the doctrine of equivalents.

1. A power control system, the power control system comprising:
a pluggable power source (PPS) junction box operable to receive and aggregate power from one or more energy sources;
a PPS controller operable to control an enable signal and provide the power to an energy storage device or direct load device;
a PPS interface operable to communicate the power from the PPS junction box to the PPS controller and communicate the enable signal from the PPS controller to the PPS junction box;
wherein the PPS controller controls the enable signal responsive to at least (i) an amount of power available from the one or more energy sources and (ii) an amount of energy stored at the energy storage device or required to supply the direct load device; and
wherein the PPS interface communicates the power from the PPS junction box to the PPS controller based on the enable signal.

2. The power control system of claim 1, wherein a maximum voltage of the power is based on a voltage applied to the enable signal.

3. The power control system of claim 2, wherein the power has a first maximum voltage when the voltage applied to the enable signal is below a threshold value, and wherein the power has a second maximum voltage when the voltage applied to the enable signal is above the threshold value.

4. The power control system of claim 1, wherein the PPS interface comprises four wires, and wherein the four wires comprise positive power wire, a negative power wire, an enable wire, and an enable reference wire.

5. The power control system of claim 4, wherein the power is communicated via the power positive wire and the negative power wire, and wherein the enable signal is communicated via the enable wire and the enable reference wire.

6. The power control system of claim 1, wherein the PPS interface comprises two wires, and wherein the two wires comprise a positive bidirectional power wire and a negative bidirectional power wire.

7. The power control system of claim 6, wherein the power and the enable signal are both communicated via the positive bidirectional power wire and the negative bidirectional power wire.

8. The power control system of claim 1, wherein the PPS controller controls the enable signal further responsive to a cable connected signal indicating a cable has connected the PPS junction box to the PPS controller.

9. The power control system of claim 8, wherein the PPS controller determines the cable has connected the PPS junction box to the PPS controller using a non-contact magnetic circuit.

10. The power control system of claim 1, wherein the PPS controller and the PPS junction box negotiate a type and class of power via pulsing voltage or pulsing current on the PPS interface.

11. The power control system of claim 1, wherein the PPS junction box comprises at least one relay and at least one solid-state device connected in series between one or more solar panels and the PPS interface, and wherein the PPS junction box controls the at least one relay and the at least one solid-state device are controlled by the PPS junction box such that the PPS interface is intrinsically safe when the enable signal is not enabled or when a fault is detected.

12. The power control system of claim 11, wherein the at least one relay and the at least one solid state device provide a plurality of power output levels.

13. The power control system of claim 11, wherein the PPS junction box switches the relay from a closed state to an open state after switching the solid-state device from an enabled state to a disabled state when power is not communicated via the PPS interface, and wherein the PPS junction box switches the relay from the open state to the closed state before switching the solid-state device from the disabled state to the enabled state when power is communicated via the PPS interface.

14. The power control system of claim 1, wherein the PPS controller comprises a manual disconnect switch that disables the enable signal.

15. The power control system of claim 1, wherein the PPS controller disables the enable signal responsive to determining that a voltage of the power is below a threshold value.

16. The power control system of claim 1, wherein an intermediate pluggable junction along the PPS interface disconnects the enable signal from the intermediate pluggable junction based on non-contact magnetic circuit indicating a loss of mating.

17. The power control system of claim 1, wherein the PPS junction box and the PPS controller maintain data communication and operational power along the enable signal using pulse width modulation of both current and amplitude.

18. The power control system of claim 1, wherein the PPS junction box provides output power safety protection comprising (i) ground fault interruption, (ii) arc fault interruption, (iii) over-current, and (iv) voltage range protection.

19. The power control system of claim 1, wherein the PPS controller provides output power switching to a plurality of loads.

20. A power control system for solar panels, the power control system comprising:
a pluggable solar panel (PSP) junction box operable to receive and aggregate power from one or more solar panels;
a PSP controller operable to control an enable signal and provide the power to an energy storage device;
a PSP interface operable to communicate the power from the PSP junction box to the PSP controller and communicate the enable signal from the PSP controller to the PSP junction box;
wherein the PSP controller controls the enable signal responsive to at least (i) an amount of power available from the one or more solar panels and (ii) an amount of energy stored at the energy storage device; and
wherein the PSP interface communicates the power from the PSP junction box to the PSP controller based on the enable signal.
